(19) United States
(12) Patent Application Publication
(10) Pub. No.: US 2017/0187435 A1
(43) Pub. Date: Jun. 29, 2017

(54) INITIATING AND PROTECTING MULTI-USER MULTIPLE INPUT MULTIPLE OUTPUT TRANSMISSIONS IN COMMUNICATION NETWORKS

(71) Applicant: Intel IP Corporation, Santa Clara, CA (US)

(72) Inventors: Laurent Cariou, Portland, OR (US); Carlos Cordeiro, Portland, OR (US); Assaf Kasher, Haifa (IL); Solomon Trainin, Haifa (IL); Chittabrata Ghosh, Fremont, CA (US)

(21) Appl. No.: 14/757,725

(22) Filed: Dec. 23, 2015

(51) Int. Cl. H04B 7/04; H04W 74/00

(52) U.S. Cl. CPC H04B 7/0452; H04W 74/008

(57) ABSTRACT

Methods, apparatus, systems and articles of manufacture (e.g., physical storage media) to initiate and protect multi-user multiple input multiple output (MU-MIMO) transmissions in communication networks are disclosed. Example MU-MIMO communication methods disclosed herein include preparing a MU-MIMO setup frame specifying duration information for a subsequent MU-MIMO frame to be transmitted and a group of stations to receive the subsequent MU-MIMO frame. Disclosed example MU-MIMO communication methods also include transmitting the MU-MIMO setup frame, and after the transmitting of the MU-MIMO setup frame, transmitting the MU-MIMO frame.

### FIELD OF THE DISCLOSURE

This disclosure relates generally to communication networks and, more particularly, to initiating and protecting multi-user multiple input multiple output transmissions in communication networks.

### BACKGROUND

Some modern wireless communication networks support multiple input multiple output (MIMO) techniques in which a communication device employs multiple transmit and/or receive antennas to transmit and/or receive multiple data signals simultaneously over a communication medium. Some such communication networks further support multi-user MIMO (MU-MIMO) techniques, in which spatial diversity, such as directional transmissions, are further employed to permit MIMO communications to be exchanged among multiple devices simultaneously over the communication medium. For example, in communication networks conforming to the Institute of Electrical and Electronics Engineers (IEEE) 802.11ay standard, which is currently under development, MU-MIMO transactions will be provided on top of directional multi-gigabit (DMG) and enhanced DMG (EDMG) link access mechanisms. However, only some of the stations in the one or more directions of a given MU-MIMO transaction may be participants in that MU-MIMO transaction.

### BRIEF DESCRIPTION OF THE DRAWINGS

FIG. 1 is a block diagram of an example communication network capable of initiating and protecting MU-MIMO transmissions in accordance with the teachings of this disclosure.

FIG. 2 is a block diagram of an example access point that may be used to implement the example communication network of FIG. 1.

FIG. 3 is a block diagram of an example station that may be used to implement the example communication network of FIG. 1.

FIG. 4 illustrates example operations performed in the example communication network of FIG. 1 to initiate an example MU-MIMO transmission using an example MU-MIMO setup frame.

FIG. 5 illustrates an example implementation of the example MU-MIMO setup frame of FIG. 4.

FIG. 6 illustrates example processing of the example MU-MIMO setup frames of FIGS. 3 and/or 4 to initiate and protect transmission of a subsequent MU-MIMO frame in the example communication network of FIG. 1.

FIGS. 7-8 illustrate further example operations performed in the example communication network of FIG. 1 to protect transmission of a subsequent MU-MIMO frame in the example communication network of FIG. 1 using the example MU-MIMO setup frames of FIGS. 3 and/or 4 and example clear-to-send (CTS) messages.

FIG. 9 illustrates example processing of an example grant message to initiate an example MU-MIMO transmission in the example communication network of FIG. 1.

FIG. 10 illustrates an example implementation of the example grant message of FIG. 9.

FIG. 11 illustrates example directional transmissions of the example grant message of FIGS. 9 and/or 10 by an example access point to multiple example stations in the example communication network of FIG. 1.

FIGS. 12-13 are flowcharts representative of example machine readable instructions that may be executed to implement the example access point of FIG. 2.

FIGS. 14-15 are flowcharts representative of example machine readable instructions that may be executed to implement the example station of FIG. 3.

FIG. 16 is a block diagram of an example processor platform structured to execute the example machine readable instructions of FIGS. 12 and/or 13 to implement the example access point of FIG. 2.

FIG. 17 is a block diagram of an example processor platform structured to execute the example machine readable instructions of FIGS. 14 and/or 15 to implement the example station of FIG. 3.

The figures are not to scale. Wherever possible, the same reference numbers will be used throughout the drawing(s) and accompanying written description to refer to the same or like parts, elements, etc.

### DETAILED DESCRIPTION

Methods, apparatus, systems and articles of manufacture (e.g., physical storage media) to initiate and protect multi-user multiple input multiple output (MU-MIMO) transmissions in communication networks are disclosed herein. Example MU-MIMO communication methods disclosed herein, which may be implemented by, for example, an access point and/or a station that is to initiate an MU-MIMO transmission, include preparing an MU-MIMO setup frame specifying duration information for a subsequent MU-MIMO frame to be transmitted. The MU-MIMO setup frame also specifies a group of stations to receive the subsequent MU-MIMO frame. Some such disclosed example methods also include transmitting the MU-MIMO setup frame and, after the transmitting of the MU-MIMO setup frame, transmitting the MU-MIMO frame.

In some such disclosed example methods, the MU-MIMO setup frame is implemented by a CTS-to-self frame including elements to specify the duration information for the subsequent MU-MIMO frame and the group of stations to receive the subsequent MU-MIMO frame. (The term “CTS” is an acronym for the term “clear-to-send.”)

Additionally or alternatively, in some such disclosed example methods, the MU-MIMO setup frame includes an information element specifying respective receiver addresses corresponding to respective ones of the stations that are to receive the subsequent MU-MIMO frame. Additionally or alternatively, in some such disclosed example methods, the MU-MIMO setup frame includes a group receiver address associated with the group of stations.

Additionally or alternatively, in some such disclosed example methods, the transmitting of the MU-MIMO setup frame includes transmitting the MU-MIMO setup frame in multiple directions using a first multidirectional physical layer channel different from a second multidirectional physical layer channel used to transmit the MU-MIMO frame. Furthermore, in some such disclosed example methods, the transmitting of the MU-MIMO frame includes transmitting a first portion of the MU-MIMO frame in the multiple directions using the second multidirectional physical layer channel without MIMO precoding, and transmitting a second portion of the MU-MIMO frame in the multiple directions using the second multidirectional physical layer channel with MIMO precoding.

Additionally or alternatively, in some such disclosed example methods, the MU-MIMO setup frame includes a CTS feedback element specifying whether a CTS response is to be transmitted by the group of stations specified in the MU-MIMO setup frame. Furthermore, some such disclosed example methods include receiving a first CTS response from a first one of the group of stations after the transmitting of the MU-MIMO setup frame. Some such disclosed example methods further include transmitting a polling message to the first one of the group of stations prior to the receiving of the first CTS response.

Additionally or alternatively, some such disclosed example methods further include, prior to the transmitting of the MU-MIMO setup frame, monitoring a communication medium in multiple directions corresponding to the group of stations to perform a clear channel assessment. Some such disclosed example methods also include triggering the transmitting of the MU-MIMO setup frame to occur in response to the clear channel assessment indicating the communication medium is clear in the multiple directions.

Additionally or alternatively, some such disclosed example methods further include preparing a grant message including time information specifying a rendezvous time at which the MU-MIMO setup frame is to be transmitted. Some such disclosed example methods also include transmitting the grant message, and then triggering the transmitting of the MU-MIMO setup frame to occur based on the rendezvous time.

Example MU-MIMO communication methods disclosed herein, which may be implemented by, for example, a network station in a communication network, include, in response to receiving an MU-MIMO setup frame, determining whether receiver address information included in the MU-MIMO setup frame corresponds to a first receiver address associated with the network station. Some such disclosed example methods also include, in response to the receiver address information corresponding to the first receiver address, configuring receiving of a subsequent MU-MIMO frame at the network station based on duration information specified in the MU-MIMO setup frame. Some such disclosed example methods further include, in in response to the receiver address information not corresponding to the first receiver address, configuring a network allocation vector based on the duration information specified in the MU-MIMO setup frame to prevent the network station from transmitting on a communication medium while the subsequent MU-MIMO frame is being transmitted on the communication medium.

In some such disclosed example methods, the receiver address information is an individual receiver address included in an information element of the MU-MIMO setup frame, and the first receiver address is a unique receiver address assigned to the network station. In some such disclosed example methods, the receiver address information corresponds to a group address included in a receiver address element of the MU-MIMO setup frame, and the first receiver address is a first group address assigned to a first group of stations including the network station.

Additionally or alternatively, in some such disclosed example methods, the configuring of the receiving of the subsequent MU-MIMO frame at the network station includes configuring the network station to receive the MU-MIMO frame using a second multidirectional physical layer channel different from a first multidirectional physical layer channel via which the MU-MIMO setup frame was received. Furthermore, in some such disclosed example methods, the configuring of the receiving of the subsequent MU-MIMO frame at the network station further includes configuring the network station to receive a first portion of the MU-MIMO frame without MIMO precoding, and configuring the network station to receive a second portion of the MU-MIMO frame with MIMO precoding.

Additionally or alternatively, some such disclosed example methods further include, in response to the receiver address information corresponding to the first receiver address, determining whether the MU-MIMO setup frame further includes a clear-to-send (CTS) feedback element. Some such disclosed example methods also include, in response to the CTS feedback element indicating CTS feedback is to be transmitted, transmitting a CTS message responsive to the MU-MIMO setup frame. Some such disclosed example methods further include triggering the transmitting of the CTS message to occur in response to receiving a polling message.

Additionally or alternatively, some such disclosed example methods further include, in response to receiving a CTS message, configuring the network allocation vector to prevent the network station from transmitting on the communication medium for a first duration beginning after receipt of the CTS message.

Additionally or alternatively, some such disclosed example methods further include, in response to receiving a grant message, determining whether group address information included in the grant message corresponds to a first group address associated with a first group of stations including the network station. Some such disclosed example methods also include, in response to the group address information corresponding to the first group address, configuring the receiving of the MU-MIMO setup frame based on duration information specified in the grant message.

These and other example methods, apparatus, systems and articles of manufacture (e.g., physical storage media) to initiate and protect MU-MIMO transmissions in communication networks are disclosed in greater detail below.

As noted above, wireless communication networks conforming to the IEEE 802.11ay standard will be expected to support MU-MIMO transactions provided on top of directional multi-gigabit (DMG) and enhanced DMG (EDMG) link access mechanisms. However, only some of the stations in the one or more directions of a given MU-MIMO transaction may be participants in that MU-MIMO transaction. As such, other stations in these same one or more directions may already be involved in, and/or wish to initiate, other communication transactions, which could interfere with a given MU-MIMO transmission. Thus, there is a need to provide technical solutions for a myriad of technical problems associated with providing support for MU-MIMO transmissions in IEEE 802.11ay networks, as well as other communication networks.

Example methods, apparatus, systems and articles of manufacture (e.g., physical storage media) to initiate and protect MU-MIMO transmissions, as disclosed herein, provide technical solutions to many such technical problems in IEEE 802.11ay networks, as well as other communication networks. For example, disclosed example MU-MIMO transmission initiation techniques provide technical solutions for implementing an example multidirectional/multi-antenna clear channel assessment (CCA) mechanism to determine whether a communication medium is clear before initiating an MU-MIMO transmission during a contention based access period (CRAP). Disclosed example MU-MIMO transmission initiation techniques also provide technical solutions for implementing an example multidirectional MU-MIMO setup frame capable of providing advance notice to destination stations that they will be involved in a subsequent MU-MIMO transaction (e.g., to inform the destination stations that they will be recipients of a subsequent MU-MIMO frame to be transmitted via the communication medium). Disclosed example MU-MIMO transmission protection techniques further provide technical solutions for implementing multidirectional protection mechanisms utilizing example network allo′cation vectors configured based on received MU-MIMO setup frames and/or other example messages, such as clear-to-send (CTS) messages and/or request-to-send (RTS) messages, which prevent stations that are not involved in a given MU-MIMO transaction from interfering with that MU-MIMO transaction. These and other benefits are capable of being achieved with the disclosed example methods, apparatus, systems and articles of manufacture (e.g., physical storage media) for initiating and protecting MU-MIMO transmissions in communication networks.

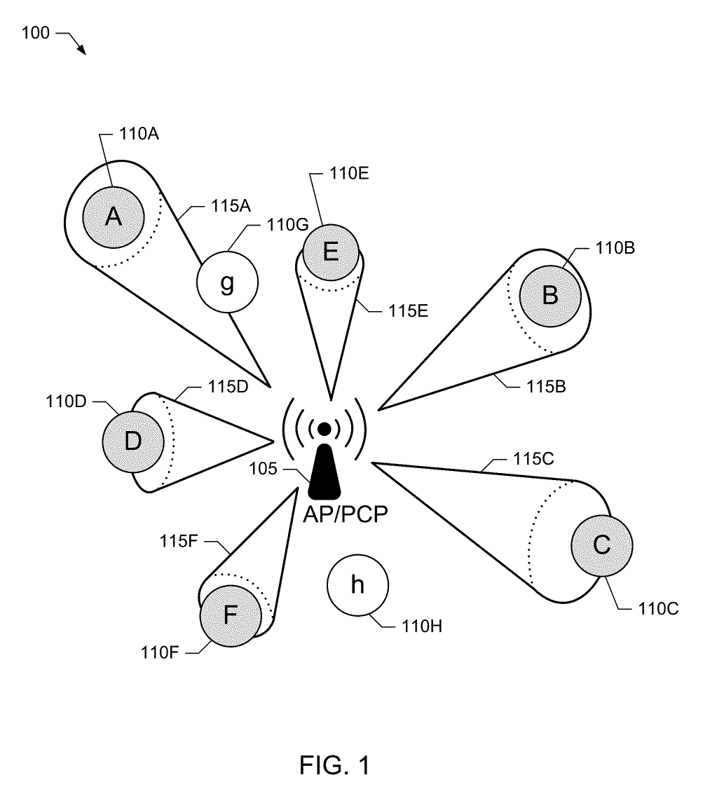

Turning to the figures, a block diagram of an example communication network 100 capable of initiating and protecting of MU-MIMO transmissions in accordance with the teachings of this disclosure is illustrated in FIG. 1. The communication network 100 of the illustrated example corresponds to an example IEEE 802.11ay wireless communication network operating in the 60 gigahertz (GHz) radio frequency (RF) spectrum. However, the examples disclosed herein are not limited to implementation in such an IEEE 802.11ay network, but can be implemented in any communication network supporting MU-MIMO transactions.

The example communication network 100 of FIG. 1 includes an example network access point 105 in communication with example network stations 110A-H. The example access point 105 can be implemented by any type(s) and/or number(s) of access points, base stations, cell sites, etc., supporting any type(s) and/or number(s) of communication standards, such as, but not limited to, the IEEE 802.11ay standard. In some examples, the access point 105 also implements a personal basic service set (PBSS) control point (PCP) in accordance with the IEEE 802.11 standards.

Similarly, the example stations 110A-H can be implemented by any type(s) and/or number(s) stations, mobile devices, smartphones, computing devices, etc., supporting any type(s) and/or number(s) of communication standards, such as, but not limited to, the IEEE 802.11ay standard. Although the example network 100 is illustrated as including one example access point 105 and eight example stations 110A-H, the examples disclosed herein are not limited therefore, but can be implemented in a communication network including any number of access points 105 and/or any number of stations 110A-H.

As used herein, the phrase “in communication,” including variances thereof, encompasses direct communication and/or indirect communication through one or more intermediary components and does not require direct physical (e.g., wired and/or wireless) communication and/or constant communication, but rather additionally includes selective communication at periodic or aperiodic intervals, as well as one-time events.

In the illustrated example of FIG. 1, the access point 105 includes multiple antennas to support directional communication (e.g., via beamforming) with the example network stations 110A-H. In some examples, the access point 105 may include different sets of antennas for transmitting and receiving, whereas in other examples, the access point 105 may use the same set of antennas for both transmitting and receiving. Similarly, in the illustrated example of FIG. 1, the example network stations 110A-F each include multiple antennas to support directional communication (e.g., via beamforming) with the example access point 105 (and/or other stations in the network 100). Similar to the example access point 105, one or more of the network stations 110A-F may include different sets of antennas for transmitting and receiving, whereas one or more of the network stations 110A-F may use the same set of antennas for both transmitting and receiving. In the illustrated example of FIG. 1, the example network stations 110G-H may or may not include multiple antennas to support directional communication (e.g., via beamforming) with the example access point 105 (and/or other stations in the network 100).

For example, the access point 105 and the network stations 110A-F of FIG. 1 determine respective antenna weight vectors (AWVs) for their respective sets of antennas to allow the example access point 105 to send respective example directional transmissions 115A-F to the network stations 110A-F. The example access point 105 and the example network stations 110A-F also support MU-MIMO transactions such that different data (or the same data, or combinations thereof) can be sent by the access point 105 to the different stations 110A-F simultaneously via the example directional transmissions 115A-F. Furthermore, the example access point 105 and the example network stations 110A-H implement example mechanisms disclosed herein to initiate and protect such MU-MIMO transmissions.

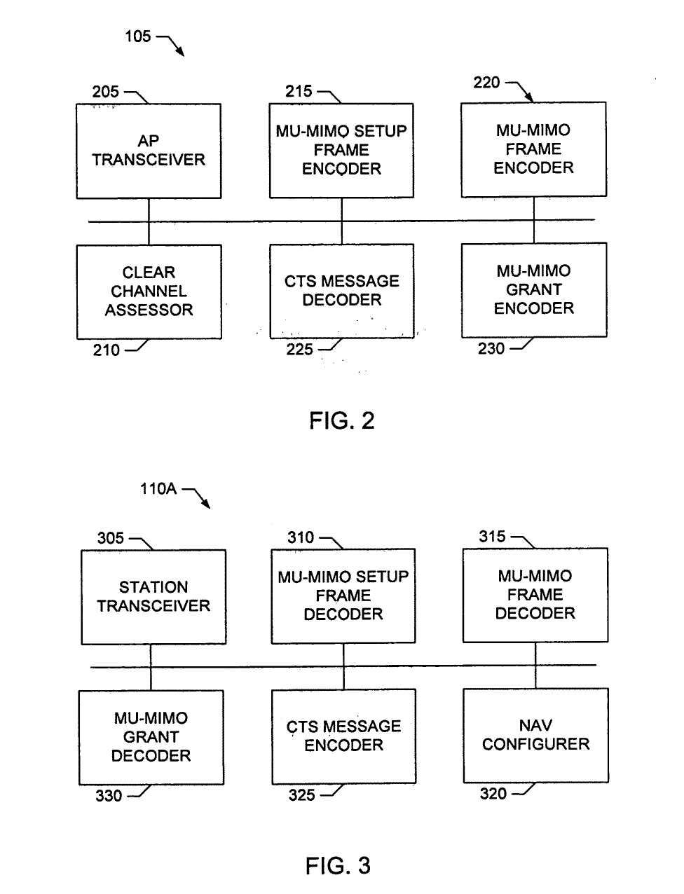

An example implementation of the access point 105 of FIG. 1, which includes functionality to initiate and protect MU-MIMO transmissions in accordance with the teachings of this disclosure, is illustrated in FIG. 2. Other functionality that may be provided by the example access point 105 is omitted for clarity. The example access point 105 of FIG. 2 includes an example access point (AP) transceiver 205 including any appropriate transmitter and receiver hardware, firmware, software, etc., to transmit and receive signals via the communication medium of the example communication network 100 of FIG. 1. For example, the AP transceiver 205 may be structured to transmit and receive signals in various communication channels specified in the 60 GHz spectrum of an IEEE 802.11ay network. In the illustrated example, the AP transceiver 205 also includes multiple antennas configurable via one or more AWVs to support sending and/or receiving directional transmissions, such as the directional transmissions 115A-F, to and/or from stations, such as the example stations 110A-F of FIG. 1.

To initiate and protect MU-MIMO transmissions in accordance with the teachings of this disclosure, the example access point 105 of FIG. 2 also includes an example clear channel assessor 210, an example MU-MIMO setup frame encoder 215, an example MU-MIMO frame encoder 220, an example CTS message decoder 225 and an example MU-MIMO grant encoder 230. In other example implementations, the access point 105 may include different subset(s) of the example clear channel assessor 210, the example MU-MIMO setup frame encoder 215, the example MU-MIMO frame encoder 220, the example CTS message decoder 225 and/or the example MU-MIMO grant encoder 230 to implement respective subset(s) of the MU-MIMO transmission initiation and/or protection functionality disclosed herein. Further implementation and operation details for the example clear channel assessor 210, the example MU-MIMO setup frame encoder 215, the example MU-MIMO frame encoder 220, the example CTS message decoder 225 and the example MU-MIMO grant encoder 230 are provided below.

An example implementation of the network station 110A of FIG. 1, which includes functionality to initiate and protect MU-MIMO transmissions in accordance with the teachings of this disclosure, is illustrated in FIG. 3. Other functionality that may be provided by the example network station 110A is omitted for clarity. Furthermore, the example elements illustrated in FIG. 3 may be used to implement one or more of the other example network stations 110B-H of FIG. 1.

The example network station 110A of FIG. 3 includes an example station transceiver 305 including any appropriate transmitter and receiver hardware, firmware, software, etc., to transmit and receive signals via the communication medium of the example communication network 100 of FIG. 1. For example, the station transceiver 305 may be structured to transmit and receive signals in various communication channels specified in the 60 GHz spectrum of an IEEE 802.11ay network. In the illustrated example, the station transceiver 305 also includes multiple antennas configurable via one or more AWVs to support sending and/or receiving directional transmissions, such as the directional transmissions 115A-F, to and/or from access points, such as the example access point 105 of FIG. 1.

To initiate and protect MU-MIMO transmissions in accordance with the teachings of this disclosure, the example network station 110A of FIG. 3 also includes an example MU-MIMO setup frame decoder 310, an example MU-MIMO frame decoder 315, an example NAV configurer 320, an example CTS message encoder 325 and an example MU-MIMO grant decoder 330. In other example implementations, the network station 110A may include different subset(s) of the example MU-MIMO setup frame decoder 310, the example MU-MIMO frame decoder 315, the example NAV configurer 320, the example CTS message encoder 325 and/or the example MU-MIMO grant decoder 330 to implement respective subset(s) of the MU-MIMO transmission initiation and/or protection functionality disclosed herein. Further implementation and operation details for the example MU-MIMO setup frame decoder 310, the example MU-MIMO frame decoder 315, the example NAV configurer 320, the example CTS message encoder 325 and the example MU-MIMO grant decoder 330 are provided below.

Returning to FIG. 2, the example access point 105 illustrated therein includes the example clear channel assessor 210 to monitor a communication medium (e.g., one or more communication channels in the 60 GHz spectrum) in multiple directions corresponding to a group of stations to perform a clear channel assessment (CCA) of the communication medium prior to accessing the medium to send a MU-MIMO transmission to the group of stations during, for example, a CBAP. The example clear channel assessor 210 then triggers accessing of the communication medium and transmitting of the MU-MIMO transmission (e.g., which may be an example MU-MIMO setup frame, which is disclosed in further detail below) to occur in response to the CCA indicating that the communication medium is clear (e.g., idle) in the multiple directions being monitored. In some examples, the clear channel assessor 210 performs its CCA by implementing any appropriate carrier sense multiple access—collision avoidance (CSMA-CA) technique in the multiple directions the AP 105 will send its subsequent MU-MIMO transmission (e.g., the example MU-MIMO setup frame disclosed in further detail below). Such functionality protects the subsequent MU-MIMO transmission from interference by other transmissions already occupying the communication medium.

In some examples, prior to attempting to access the communication medium to send a given MU-MIMO transmission, the access point 105 may have already conducted MU-MIMO beamforming training to define the AWVs, and/or the appropriate antenna(s) and/sector(s), for sending directional transmissions (e.g., such as the transmissions 115A-C) to the different destination stations (e.g., such as the stations 110A-C) that are to receive the given MU-MIMO transmission. In some examples, the access point 105 may also have already determined, in any appropriate manner, MU-MIMO digital precoding matrices to be applied to the different data to be sent via the MU-MIMO transmission simultaneously to the different destination stations in order to reduce the interference between the simultaneous data flows. In some such examples, to implement a multidirectional/multi-antenna CCA procedure, the clear channel assessor 210 uses the AWVs, and/or the appropriate antenna(s) and/sector(s), determined for the different destination stations, to set the receive antennas of the access point 105 in the directions to be monitored, and performs a CSMA-CA procedure in each direction. If the communication medium is determined to be clear (e.g., idle) in the different directions, the clear channel assessor 210 triggers or otherwise enables the subsequent, multidirectional MU-MIMO transmission to be sent to the destination stations. In some examples, the clear channel assessor 210 determines that the communication medium (e.g., one or more channels) in a given direction is clear (e.g., idle) if the energy received over the communication medium with the antennas set to the direction satisfies (e.g., is less than, or is less than or equal to) an energy threshold, and determines that the communication medium (e.g., one or more channels) in the given direction is not clear (e.g., is active) if the energy received over the communication medium with the antennas set to the direction does not satisfy (e.g., is greater than, or is greater than or equal to) the energy threshold.

In the illustrated example of FIG. 2, the access point 105 includes the example MU-MIMO setup frame encoder 215 to, encode an example, novel MU-MIMO setup frame to be sent by the example AP transceiver 205 to provide advance notice to destination stations that they will be involved in a subsequent MU-MIMO transaction. For example, the MU-MIMO setup frame encoder 215 may prepare the MU-MIMO setup frame to notify the group of destination stations 110A-C that they will be the recipients of a subsequent MU-MIMO frame, which is to be prepared by the example MU-MIMO frame encoder 220. As such, and as disclosed in further detail below, the example MU-MIMO setup frame encoded by the example MU-MIMO setup frame encoder 215 may specify duration information for a subsequent MU-MIMO frame to be transmitted by the access point 105. The example MU-MIMO setup frame may also specify a group of stations (e.g., the stations 110A-C) that are to receive the subsequent MU-MIMO frame. In some such examples, in response to the CCA procedure performed by the clear channel assessor 210 indicating the communication medium (e.g., appropriate channel(s)) is clear in the direction(s) of the destination stations, the AP transceiver 205 then transmits the example MU-MIMO setup frame encoded by the example MU-MIMO setup frame encoder 215. Then, after the MU-MIMO setup frame is transmitted, the AP transceiver 205 transmits the MU-MIMO frame to the destination stations (e.g., the stations 110A-C) simultaneously and multi-directionally.

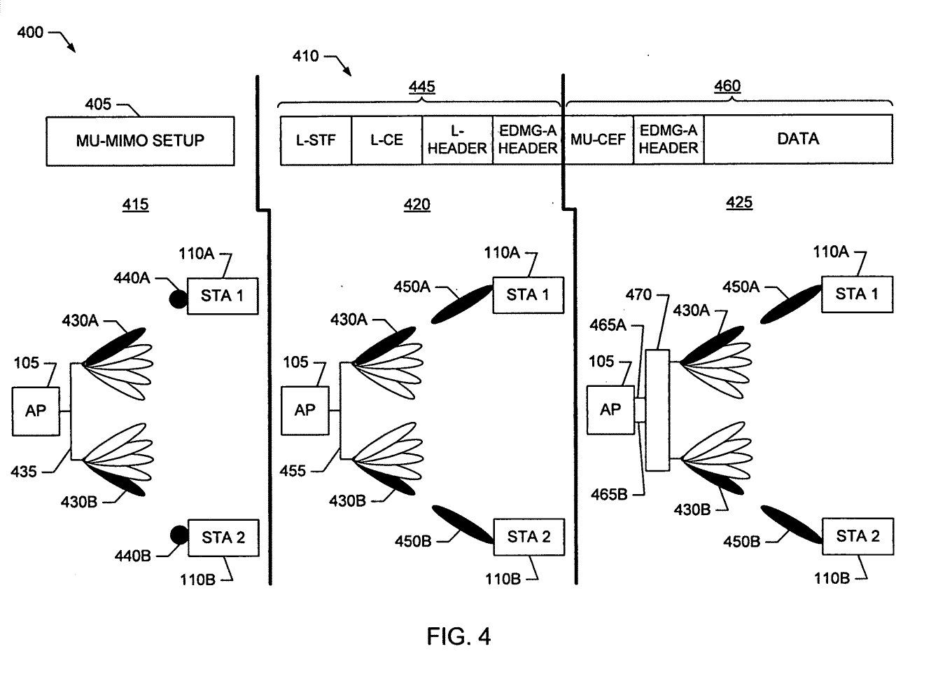

FIG. 4 illustrates further example operations 400 performed by the example access point 105 of FIG. 2 to initiate MU-MIMO transmissions using an example MU-MIMO setup frame 405 encoded by the example MU-MIMO setup frame encoder 215. In the illustrated example, the MU-MIMO setup frame 405 transmitted by the access point 105 informs the destination network stations 110A-C that they will be recipients of a subsequent example MU-MIMO frame 410 encoded by the example MU-MIMO frame encoder 220 of the access point 105. Furthermore, the example MU-MIMO setup frame 405 transmitted by the access point 105 allows other, non-destination stations (e.g., such as the example station 110G, and which are also referred to herein as third-party stations) to set their respective network allocation vectors (NAVs) to prevent transmission during the subsequent MU-MIMO frame 410, thereby allowing the third-party stations to avoid interfering with the MU-MIMO frame 410.

The example operations 400 illustrated in FIG. 4 include an example MU-MIMO setup frame transmission mode 415, an example first MU-MIMO frame transmission mode 420, and an example second MU-MIMO frame transmission mode 425. In the example MU-MIMO setup frame transmission mode 415, the access point 105 transmits the MU-MIMO setup frame 405 using a multidirectional physical layer (PHY) mode such that the MU-MIMO setup frame 405 is sent in multiple directions, which correspond to the destination stations 110A-C, using multiple transmit (Tx) antennas. (In the illustrated example, the destination station 110C is omitted to enhance clarity.) Because the access point 105 supports MU-MIMO operation, it is possible to transmit in the respective directions of the different destination stations 110A-C because the access point 105 has at least as many Tx antennas as there are destination stations of a MU-MIMO transmission.

As illustrated in the example operation 415 of FIG. 4, the access point 105 transmits the MU-MIMO setup frame 405 in the multiple directions corresponding to the destination stations 110A-C using the appropriate antenna(s) and AWV (which is represented by the ellipses 430A-B in FIG. 4) for each of the respective destination stations 110A-C. In some examples, the same MU-MIMO setup frame 405 is sent simultaneously in the different directions without applying MIMO digital precoding (which is represented by the line 435 in FIG. 4). The MU-MIMO setup frame 405 is sent without MIMO precoding to allow the MU-MIMO setup frame 405 to be decoded by third party stations not supporting MIMO operation. This allows the MU-MIMO setup frame 405 to be used by example MU-MIMO transmission protection mechanisms disclosed herein. In some examples, because the same information (e.g., the same MU-MIMO setup frame 405) is sent simultaneously in the different directions without applying MIMO digital precoding, the access point 105 applies different delays to one or more of the signals being transmitted in the different directions to reduce the possibility of transmitted signals interfering destructively at the receiving stations.

As illustrated in the example operation 415 of FIG. 4, in some examples, prior to transmission of the MU-MIMO setup frame 405, the destination stations 410A-C of the MU-MIMO setup frame 405 are not aware that the access point 105 intends to transmit the subsequent MU-MIMO frame 410 to them during a CBAP. As such, the destination stations 410A-C may not have their respective antennas beamformed towards the access point 105 (which is represented by the circles 440A-B in FIG. 4). As such, the receiver gain associated with beamforming may not be available to the destination stations 410A-C during receipt of the MU-MIMO setup frame 405. Thus, in some examples, the access point 105 configures the AP transceiver 205 to transmit the MU-MIMO setup frame 405 using a multi-directional control PHY channel (e.g., as specified for IEEE 802.11ay networks) characterized by having more robust encoding but lower throughput than other PHY channels (e.g., such as the PHY channel(s) used to transmit the subsequent MU-MIMO frame 410).

In the example first MU-MIMO frame transmission mode 420, the access point 105 transmits an example first portion 445 of the MU-MIMO frame 410 using a PHY mode such that the first portion 445 of the MU-MIMO frame 410 is sent in multiple directions corresponding to the destination stations 110A-C using the multiple Tx antennas of the access point 105. In the illustrated example, the first portion 445 of the MU-MIMO frame 410 includes header information that is common (e.g., the same) for the group of destination stations 110A-C that is to receive the MU-MIMO frame 410. For example, the first portion 445 of the MU-MIMO frame 410 includes an example legacy short training field or element (labelled “L-STF” in FIG. 4) to support automatic gain control (AGC) and synchronization at the receiver, an example legacy channel estimation field or element (labelled “L-CE” in FIG. 4) containing pilot symbols to support channel estimation at the receiver, an example legacy header field or element (labelled “L-HEADER” in FIG. 4) containing signaling information, and a first example EDMG header field or element (labelled “EDMG-A HEADER” in FIG. 4) containing first header information for EDMG operation.

As illustrated in the example operation 420 of FIG. 4, the access point 105 transmits the first portion 445 of the MU-MIMO frame 410 in the multiple directions corresponding to the destination stations 110A-C using the appropriate antenna(s) and AWV (which is represented by the ellipses 430A-B in FIG. 4) for each of the respective destination stations 110A-C. In some examples, the destination stations 110A-C are able to use the prior received MU-MIMO setup frame 405 to determine appropriate AWVs and/or to otherwise set their respective receive (Rx) antennas to be beamformed towards the direction of the access point 105 (which is represented by the ellipses 450A-B in FIG. 4) prior to receipt of the first portion 445 of the MU-MIMO frame 410. As such, the receiver gain associated with beamforming may be available to the destination stations 110A-C during receipt of the first portion 445 of the MU-MIMO frame 410. Thus, in some examples, the access point 105 configures the AP transceiver 205 to transmit the first portion 445 of the MU-MIMO frame 410 using a multi-directional PHY channel, such as a single carrier (SC) or orthogonal frequency division multiplexed (OFDM) PHY channel (e.g., as specified for IEEE 802.11ay networks) characterized by having less robust encoding but higher throughput than the PHY channel(s) used to transmit the prior MU-MIMO setup frame 405. However, in some examples, for backwards compatibility, the access point 105 configures the AP transceiver 205 to transmit the first portion 445 of the MU-MIMO frame 410 using a legacy multi-directional PHY channel (e.g., such as a legacy SC or OFDM PHY channel).

In some examples, the same first portion 445 of the MU-MIMO frame 410 is sent simultaneously in the different directions without applying MIMO digital precoding (which is represented by the line 455 in FIG. 4). This allows the first portion 445 of the MU-MIMO frame 410 to be decoded by legacy stations (e.g., not support MU-MIMO digital precoding). In some examples, because the same information (e.g., the same first portion 445 of the MU-MIMO frame 410) is sent simultaneously in the different directions without applying MIMO digital precoding, the access point 105 applies different delays to one or more of the signals being transmitted in the different directions to reduce the possibility of the transmitted signals interfering destructively at the receiving stations.

In the example second MU-MIMO frame transmission mode 425, the access point 105 transmits an example second portion 460 of the MU-MIMO frame 410 using a PHY mode such that the first portion 445 of the MU-MIMO frame 410 is sent in multiple directions corresponding to the destination stations 110A-C using the multiple Tx antennas of the access point 105. In the illustrated example, the second portion 460 of the MU-MIMO frame 410 includes information that may be different for different ones of the group of destination stations 110A-C receiving the MU-MIMO frame 410. For example, the second portion 460 of the MU-MIMO frame 410 includes an example multi-user channel estimation field or element (labelled “MU-CEF” in FIG. 4) containing pilot symbols to support multi-user channel estimation at the receiver, a second example EDMG header field or element (labelled “EDMG-B HEADER” in FIG. 4) containing second header information for EDMG operation, and a data field or element (labelled “DATA” in FIG. 4) containing the particular data payload (e.g., medium access control (MAC) payload) to be sent to respective ones of the group of destination stations 110A-C.

As illustrated in the example operation 420 of FIG. 4, the access point 105 transmits the second portion 460 of the MU-MIMO frame 410 in the multiple directions corresponding to the destination stations 110A-C using the appropriate antenna(s) and AWV (which is represented by the ellipses 430A-B in FIG. 4) for each of the respective destination stations 110A-C. Similarly, in the illustrated example, the destination stations 110A-C use the previously determined AWVs and/or otherwise set their respective Rx antennas to be beamformed towards the direction of the access point 105 (which is represented by the ellipses 450A-B in FIG. 4) for receipt of the second portion 460 of the MU-MIMO frame 410. As such, the receiver gain associated with beamforming may be available to the destination stations 110A-C during receipt of the second portion 460 of the MU-MIMO frame 410.

As mentioned above, the data included in the second portion 460 of the MU-MIMO frame 410 may be different for the different destination stations 110A-C (which is represented by the different lines 465A-B in FIG. 4, which correspond, respectively, to the different data being sent to stations 110A-B; illustration of the data being sent to station 110C is omitted to enhance clarity). As such, in the illustrated example, the MU-MIMO frame encoder 220 of the access point 105 employs an example MIMO digital precoder 470 to apply MIMO digital precoding to the different data 465A-B prior to transmission to the destination stations. MIMO digital precoding reduces the interference between the different data signals at the destination stations 110A-C, thereby increasing the signal-to-noise ratio of desired data signal received at each one of the destination stations 110A-C. The access point then configures the AP transceiver 205 to transmit the second portion 460 of the MU-MIMO frame 410 using a multi-directional PHY channel, such as an SC or OFDM) PHY channel (e.g., as specified for IEEE 802.11ay networks) characterized by having less robust encoding but higher throughput than the PHY channel(s) used to transmit the prior MU-MIMO setup frame 405. In some examples, the same PHY channel is used to transmit both the first portion 445 and the second portion 460 of the MU-MIMO frame 410, but with MU-MIMO precoding being applied to only the second portion 460. In some examples, the access point 105 applies different delays to one or more of the different signals being transmitted in the different directions to further reduce the possibility of the transmitted signals interfering destructively at the receiving stations.

To summarize the example operations 400 illustrated in FIG. 4, in the example MU-MIMO setup frame transmission mode 415, the MU-MIMO setup frame 405 is transmitted with, for example, a multidirectional control PHY such that the same data stream is transmitted by the multiple Tx antennas of the access point 105 simultaneously in different directions towards the destination stations 110A-C, using the appropriate (e.g., optimized) AWVs for each of the destination stations 110A-C. In the example first MU-MIMO frame transmission mode 420, the first portion 445 of the MU-MIMO frame 410 is transmitted with, for example, an SC or OFDM PHY channel such that the same data stream is transmitted by the multiple Tx antennas of the access point 105 simultaneously in different directions towards the destination stations 110A-C, using the appropriate (e.g., optimized) AWVs for each of the destination stations 110A-C. In the example second MU-MIMO frame transmission mode 425, the second portion 460 of the MU-MIMO frame 410 is transmitted with, for example, an MU-MIMO encoded SC or OFDM PHY channel such that multiple different data streams are transmitted by the multiple Tx antennas of the access point 105 simultaneously in different directions towards the destination stations 110A-C, using the appropriate (e.g., optimized) AWVs and MU-MIMO precoders 470 (and, possibly, MU-MIMO post-coders) for each of the destination stations 110A-C (thereby increasing the link budget and reducing interference from other data streams at each of the destination stations 110A-C).

In some examples, the same AWVs are employed by the access point 105 in the three example operating modes 415-425 illustrated in FIG. 4. However, different digital precoding and/or post-coding may be employed by the access point 105 in the three example operating modes 415-425. As such, in some examples, the access point 105 is able to keep the AWVs unchanged during the three example operating modes 415-425, by may change the digital precoding and/or post-coding from one operating mode to another.

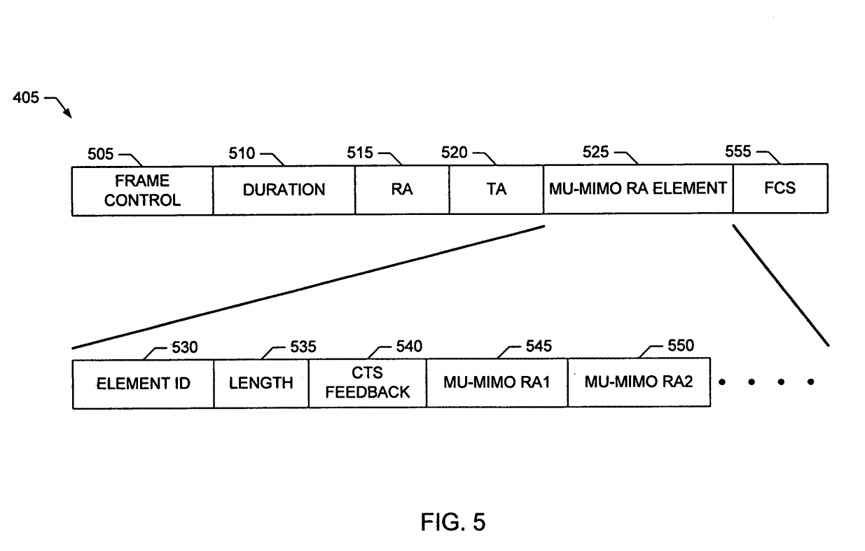

An example implementation of the MU-MIMO setup frame 405 of FIG. 4, which may be encoded by the example MU-MIMO setup frame encoder 215 of FIG. 2, is illustrated in FIG. 5. The example MU-MIMO setup frame 405 of FIG. 5 includes an example frame control field or element 505 containing control information to identify the frame as an MU-MIMO setup frame. The example MU-MIMO setup frame 405 of FIG. 5 also includes an example duration field or element 510 to specify duration information associated with the subsequent MU-MIMO frame 410 that is to follow the MU-MIMO setup frame 405. In some examples, duration element 510 specifies one or more of (i) the duration of the subsequent MU-MIMO frame 410, (ii) the duration from the end of the MU-MIMO setup frame 405 to the start of the subsequent MU-MIMO frame 410, and/or (iii) a total duration including the transmission opportunity (TxOP) associated with the subsequent MU-MIMO frame 410 (e.g., which may include the duration from the end of the MU-MIMO setup frame 405 to the start of the subsequent MU-MIMO frame 410, the duration of the subsequent MU-MIMO frame 410, and any time period for acknowledgments (ACKs) from the receiving stations), etc.

The example MU-MIMO setup frame 405 of FIG. 5 further includes an example transmitter address (TA) field or element 515 and an example receiver address (RA) field or element 520 to specify a transmitter address and a receiver address, respectively, for the MU-MIMO setup frame 405. In some example, the TA element 515 specifies the network address (e.g., Internet address, MAC address, etc.) of the transmitter of the MU-MIMO setup frame 405 (e.g., the access point 105). In some examples, the RA element 520 specifies a group receiver address corresponding to a group address or other group identifier previously assigned (via any appropriate mechanism) to the group of destination stations (e.g., the stations 110A-C) that is to receive the MU-MIMO setup frame 405.

In the illustrated example of FIG. 5, the MU-MIMO setup frame 405 includes an example MU-MIMO RA container element 525 to specify further receiver-related information is support of the example MU-MIMO initiation and protection techniques disclosed herein. For example, the MU-MIMO RA container element 525 of FIG. 5 includes an example element identifier (ID) field or element 530 containing control information to identify the element 525 as an MU-MIMO RA container element. The example MU-MIMO RA container element 525 of FIG. 5 also includes an example length field or element 535 specifying a length of the MU-MIMO RA container element 525. The example MU-MIMO RA container element 525 of FIG. 5 further includes an example CTS feedback field or element 540 specifying whether a CTS response message (also referred to herein as a CTS frame) is to transmitted by respective ones of a group of stations (e.g., such as the stations 110A-C) in response to receiving the MU-MIMO setup frame 405. The example MU-MIMO RA container element 525 of FIG. 5 also includes respective example MU-MIMO RA fields or elements 545-550 to specify the corresponding receiver addresses for the respective ones of the group of stations (e.g., such as the stations 110A-C) to which the MU-MIMO setup frame 405 is to be sent. In some examples, the MU-MIMO RA elements 545-550 specify the respective association IDs (AIDs), network addresses and/or other unique identifiers, addresses, etc., capable of addressing the individual stations (e.g., such as the stations 110A-C) to which the MU-MIMO setup frame 405 is to be sent.

In the illustrated example of FIG. 5, the MU-MIMO setup frame 405 further includes an example frame check sequence (FCS) field or element 555 to provide error checking information (e.g., such as a cyclic redundancy check (CRC) value) that can be used by receiving stations (e.g., such as the stations 110A-C) to check the integrity of the received MU-MIMO setup frame 405. In some examples, the FCS element 555 includes information sufficient to check for errors in the MU-MIMO setup frame 405. In some examples, the FCS element 555 includes information sufficient to also correct errors in the MU-MIMO setup frame 405.

In some examples, the contents of the TA element 515 and the RA element 520 of the MU-MIMO setup frame 405 are modified such that the network address (or other identifier) of the transmitter of the MU-MIMO setup frame 405 (e.g., the access point 105) is specified in the RA element 520, and the MU-MIMO RA elements 545-550 forming a concatenation of the network addresses (or other identifiers) for the group of destination stations (e.g., such as the stations 110A-C) are specified in the TA element 515. Such an example implementation can avoid a scenario in which, if the RA element 520 contained a concatenation of AIDs of the destination stations, the RA element 520 of the MU-MIMO setup frame 405 might match a full network address (or other identifier) of another station, which could cause unexpected/erroneous network behavior. Such a scenario can be avoided by this example implementation because the RA element 520, in this example, would contain the network address of, for example, the access point transmitting the MU-MIMO setup frame 405.

The example MU-MIMO setup frame 405 of FIG. 5 induces some or all of the following behavior in accordance with the teachings of this disclosure. For example, because the MU-MIMO setup frame 405 carries the individual receiver addresses (e.g., AIDs and/or other RA information specified in the example MU-MIMO RA elements 545-550) and/or a group receiver address (e.g., specified in the example RA element 520) for a group of destination stations (e.g., the stations 110A-C), the MU-MIMO setup frame 405 is able to inform the destination stations that they are to be recipients of a subsequent MU-MIMO transmission. Such advance notice allows the destination stations to, for example, set their receive AWVs in the direction of the access point 105 that is transmitting the MU-MIMO setup frame 405 and will transmit the subsequent MU-MIMO transmission (e.g., a subsequent MU-MIMO frame 410). Additionally or alternatively, because the MU-MIMO setup frame 405 carries duration information (e.g., specified in the example duration element 510) for the subsequent MU-MIMO transmission (e.g., the subsequent MU-MIMO frame 410), non-destination (e.g., third-party) stations (e.g., such as the station 110G) can set their respective NAVs to prevent transmission by the non-destination (e.g., third-party) stations during the subsequent MU-MIMO transmission (e.g., the subsequent MU-MIMO frame 410), thereby protecting that subsequent MU-MIMO transmission from interference by non-destination (e.g., third-party) stations.

In some examples, the MU-MIMO setup frame 405 includes further elements different from, or in addition to, the example elements illustrated in FIG. 5. For example, the MU-MIMO setup frame 405 can include bandwidth element(s), modulation and coding scheme (MCS) elements, etc., further specifying characteristics of the subsequent MU-MIMO transmission Additionally or alternatively, in some examples, the MU-MIMO setup frame 405 including a beamforming training request element for one or more of the destination stations to selectively instruct the different destination stations to perform beamforming training after transmission of the MU-MIMO setup frame 405 and before the subsequent MU-MIMO transmission (e.g., before transmission of the subsequent MU-MIMO frame 410).

In some examples, rather than being implemented as a separate MU-MIMO setup frame 405, the example elements and functionality associated with the MU-MIMO setup frame 405 can be implemented by one or more other frames, messages, etc., transmitted by the access point 105. For example, the access point 105 could be structured to transmit a request-to-send (RTS) frame (also referred to as an RTS message) modified to include some or all of the example elements 505-555 illustrated in FIG. 5. Additionally or alternatively, the access point 105 could be structured to transmit a grant frame modified to include some or all of the example elements 505-555 illustrated in FIG. 5. Additionally or alternatively, the access point 105 could be structured to transmit aCTS-to-self frame (also referred to as a CTS-to-self message) modified to include some or all of the example elements 505-555 illustrated in FIG. 5. A CTS-to-self frame, such as, but not limited to, the CTS-to-self frame defined in the IEEE 802.11 standards, is similar to the CTS frame/message mentioned above and described in further detail below. However, rather than being sent by a network element (e.g., a station, an access point, etc.) in response to a prior frame/message, as in the case of a convention CTS frame, the CTS-to-self frame is transmitted by a network element autonomously or, in other words, without being prompted by or otherwise being in response to a prior frame/message. Such a CTS-to-self frame can be modified in accordance with the teachings of this disclosure to include some or all of the example elements 505-555 illustrated in FIG. 5 to implement the example MU-MIMO setup frame 405. In any of the preceding examples, instead of, or in addition to, transmitting the MU-MIMO setup frame 405, the same modified RTS frame, the same modified grant frame, the same modified CTS-to-self frame, etc., could be transmitted in multiple directions by the access point 105 using its multiple Tx antennas configured with the appropriate AWVs.

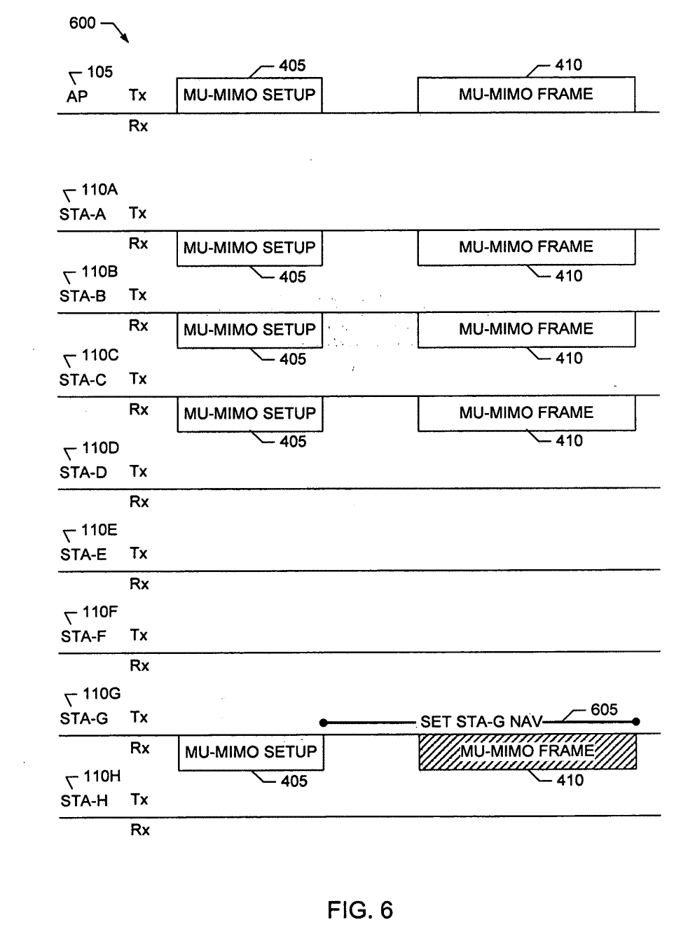

Example processing 600 capable of being performed by the example access point 105 of FIGS. 1-2 and the example stations 105A-H of FIGS. 1 and 3 to initiate and protect transmission of a subsequent MU-MIMO frame 410 using the example MU-MIMO setup frame 405 of FIGS. 4-5 is illustrated in FIG. 6. With reference to the preceding figures and associated descriptions, in the example of FIG. 6, the access point 105 transmits an example MU-MIMO setup frame 405 encoded by its example MU-MIMO setup frame encoder 215, followed by an example MU-MIMO frame 410 encoded by its example MU-MIMO frame encoder 220. In the illustrated example of FIG. 6, the access point 105 transmits the MU-MIMO setup frame 405 and the MU-MIMO frame 410 in the respective directions of the stations 110A-C, which are the destination stations for the MU-MIMO frame 410.

In the illustrated example of FIG. 6, the example MU-MIMO setup frame decoders 310 included in the respective stations 110A-C receive and decode the MU-MIMO setup frame 405. Furthermore, the MU-MIMO setup frame decoders 310 included in the respective stations 110A-C determine whether receiver address information included in the MU-MIMO setup frame 405 corresponds to receiver address(es) associated with the respective stations 110A-C. For example, the MU-MIMO setup frame decoder 310 included each of the respective stations 110A-C can determine whether (i) a group address specified in the RA element 515 of the MU-MIMO setup frame 405 corresponds to a group address previously assigned to the group of stations 110A-C, (ii) an individual receiver address (e.g., an AID) specified in one of the MU-MIMO RA elements 545-550 corresponds to a unique address assigned to the respective station 110A-C, etc., or any combination thereof.

In the illustrated example of FIG. 6, the MU-MIMO setup frame decoder 310 included in each one of the respective stations 110A-C determines that the address information included in the MU-MIMO setup frame 405 corresponds to that station. Accordingly, the MU-MIMO setup frame decoder 310 included in each one of the respective stations 110A-C configures the MU-MIMO frame decoder 315 included in the respective station to receive the subsequent MU-MIMO frame 410 based on the duration information specified in the duration field 510 of the MU-MIMO setup frame 405. In some examples, the stations 110A-C also configure their respective AWVs in the direction of the access point 105 in preparation for receiving the MU-MIMO frame 410.

In the illustrated example of FIG. 6, the example stations 110D-F and 110H do not receive the MU-MIMO setup frame 405. For example, the stations 110D-F and 110H may not be in the direction(s) of one or more of the stations 110A-C, and/or may otherwise not receive the MU-MIMO setup frame 405 with sufficient strength to successfully decode the MU-MIMO setup frame 405. As such, the stations 110D-F and 110H do not process the MU-MIMO setup frame 405 and the MU-MIMO frame 410 in the illustrated example.

In the illustrated example of FIG. 6, the example station 110G is in the direction of one or more of the stations 110A-C. Furthermore, the example MU-MIMO setup frame decoder 310 of the station 110G is able to successfully decode the MU-MIMO setup frame 405 transmitted by the access point 105. However, in the illustrated example, the MU-MIMO setup frame decoder 310 of the station 110G determines that the receiver information included in the MU-MIMO setup frame 405 does not correspond to a receiver address associated with the station 110G. As such, the MIMO setup frame decoder 310 of the station 110G does not configure the example MU-MIMO frame decoder 315 included in the station 110G to receive the subsequent MU-MIMO frame 410 (which is represented by the shaded block in FIG. 6). Instead the MIMO setup frame decoder 310 of the station 110G invokes its example NAV configurer 320 to configure the NAV of the station 110G to protect the transmission of the subsequent MU-MIMO frame 410. For example, the NAV configurer 320 of the station 110G can use the duration information specified in the duration field 510 of the MU-MIMO setup frame 405 to configure the station's NAV (e.g., which may include a timer, a counter, etc.) for an example NAV period 605 during which the station 110G is prevented from transmitting. In some examples, the NAV configurer 320 of the station 110G sets the NAV period 605 equal to the duration information specified in the duration field 510 and beginning at the end of MU-MIMO setup frame 405. In some examples, the NAV configurer 320 of the station 110G sets the NAV period 605 based on a combination of the duration information specified in the duration field 510 and one or more other time periods that are predefined or otherwise configured in the NAV configurer 320.

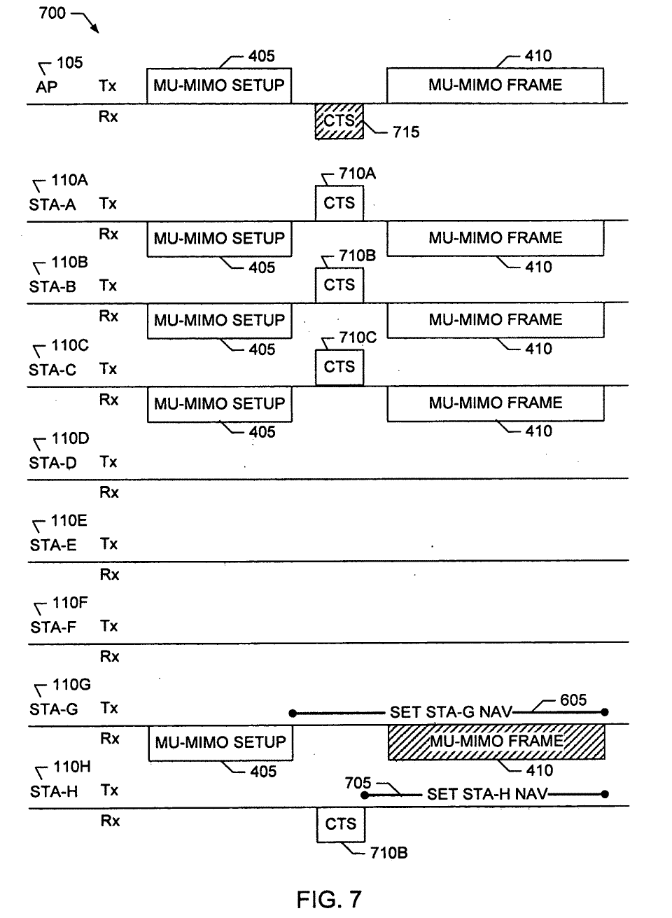

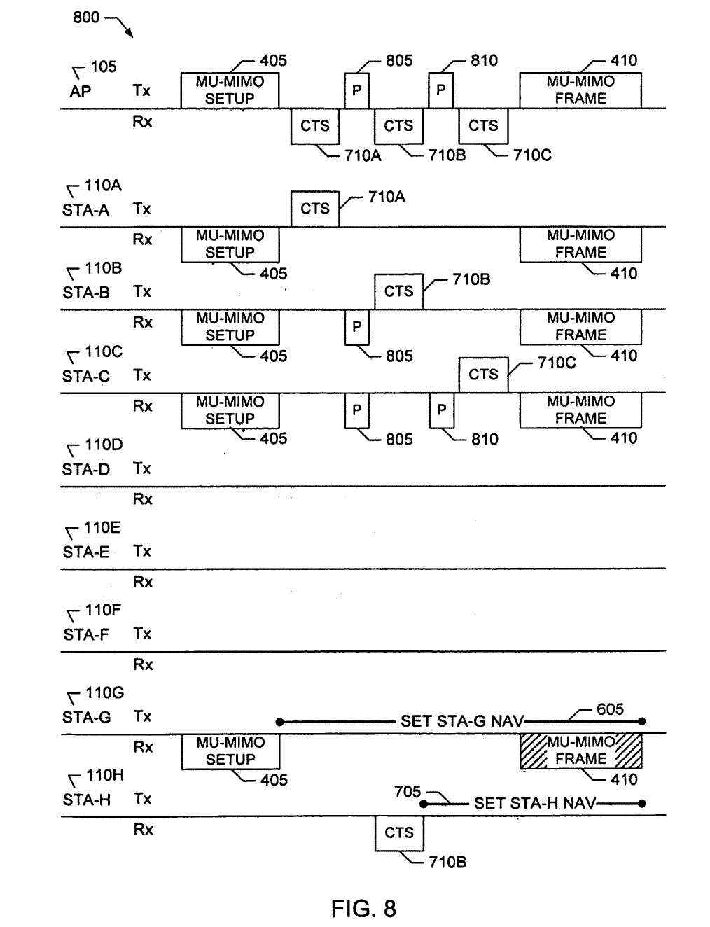

Further example processing 700 and 800 capable of performed by the example access point 105 of FIGS. 1-2 and the example stations 105A-H of FIGS. 1 and 3 to initiate and protect transmission of a subsequent MU-MIMO frame 410 using the example MU-MIMO setup frame 405 of FIGS. 4-5 and example CTS messages transmitted by the destination stations 105A-C is illustrated in FIGS. 7 and 8, respectively. As noted above, in some examples, the example duration element 510 of the MU-MIMO setup frame 405 carries the duration (or otherwise includes duration information that can be used to determine the duration) of the TxOP associated with a subsequent MU-MIMO frame 410 to be transmitted by the access point 105. As illustrated in the example of FIG. 6, such a duration element 510 of the MU-MIMO setup frame 405 allows non-destination (e.g., third-party) stations (e.g., such as the station 110G in the illustrated examples), which may be neighboring the destination stations 110A-C of the MU-MIMO setup frame 405 and, thus, able to receive the MU-MIMO setup frame 405, to set their respective NAVs to prevent transmission on the communication medium (e.g., PHY channel(s)) conveying the MU-MIMO frame 410 for a NAV period (e.g., the NAV period 605) covering the TxOP associated with the subsequent MU-MIMO frame 410.

In some examples, the MU-MIMO setup frame 405 additionally or alternatively includes the CTS feedback element 540 to instruct the destination stations of the MU-MIMO setup frame 405, such as the stations 110A-C in the illustrated examples, to send CTS response messages in response to receiving the MU-MIMO setup frame 405. (In some examples, the transmission of the CTS response messages is specified as an expected behavior and, thus, the decoding of the CTS feedback element 540 may or may not be a prerequisite to sending the CTS response message.) Such CTS response messages can also allow non-destination (e.g., third-party) stations (e.g., such as the station 110H in the illustrated examples), which may be neighboring the destination stations 110A-C of the MU-MIMO setup frame 405 and, thus, able to receive one or more of the CTS message(s) transmitted by these station(s), to set their respective NAVs to prevent transmission on the communication medium (e.g., PHY channel(s)) conveying the MU-MIMO frame 410 for a NAV period (e.g., the NAV period 705 described in further detail below) covering the TxOP associated with the subsequent MU-MIMO frame 410.

Turning to the example processing 700 of FIG. 7, the access point 105 transmits the MU-MIMO setup frame 405 and the MU-MIMO frame 410 in the respective directions of the stations 110A-C, which are the destination stations for the MU-MIMO frame 410. The MU-MIMO setup frame decoder 310 included in each one of the respective stations 110A-C determines that the address information included in the MU-MIMO setup frame 405 corresponds to that station, and also that the MU-MIMO setup frame 405 includes the CTS feedback element 540 indicating that a responsive CTS message is to be sent. In response, the respective example CTS message encoders 325 of the destination stations 110A-C encode respective example CTS messages 710A-C (also referred to herein as CTS frames 710A-C) responsive to the MU-MIMO setup frame 405. The destination stations 110A-C then send the respective CTS messages 710A-C in the direction of the access point 105 (e.g., using Tx beamforming with appropriate AWVs determined from decoding the MU-MIMO setup frame 405) within a short interframe space (SIFS) defined at the end of the MU-MIMO setup frame 405. In the illustrated example of FIG. 7, the example station transceiver 305 of the example station 110H receives the CTS message 710B transmitted by the station 110B (e.g., because the station 110H is in the neighborhood of the station 110B). In response, the example NAV configurer 320 of the station 110H configures the station's NAV (e.g., which may include a timer, a counter, etc.) for an example NAV period 705 during which the station 110H is prevented from transmitting. In some examples, the NAV period 705 corresponds to a predefined or otherwise specified time period expected to include the TxOP of the subsequent MU-MIMO frame 410.

In some such examples, the access point 105 may receive some or all of the CTS messages 710A-C simultaneously. If the content of the CTS messages 710A-C is different (e.g., due to the transmitter address in each of the CTS messages 710A-C corresponding to the respective transmitting station and, thus, being different), the CTS messages 710A-C may interfere and, thus, not be decodable by the example CTS decoder 225 of the access point 105 (e.g., unless MU-MIMO is also implemented in the uplink direction). (This behavior is represented by an example shaded box 715 in the example of FIG. 7.) (In some such examples, the ability of other, non-destination stations to use the CTS messages 710A-C to set their NAVs will be less affected by overlapping CTS messages because there is a tolerance (e.g., +/−10%) in the timing of the CTS message transmission, and only one or a subset of the CTS message transmissions are likely to be received by a neighboring station due to the directional nature of the transmissions.)

The following are example technical solutions to the technical problems associated with multiple destination stations having overlapping CTS message transmissions. In a first example technical solution, CTS messages, such as the CTS messages 710A-C, are sent by destination stations, such as the destination stations 110A-C, using a classical approach in which the transmitter address of a given CTS message corresponds to the respective address of the given station transmitting the CTS message. In such examples, the different information included in the overlapping CTS messages 710A-C may result in interference that renders the overlapping CTS messages 710A-C undecodable by the CTS decoder 225 of the access point 105. (However, the CTS decoder 225 of the access point 105 may be able to detect the energy and common preamble sections of the overlapping CTS messages 710A-C and, thus, determine that at least one responsive CTS message was sent.) In this first example technical solution, the access point 105 does not rely on receiving CTS messages to confirm receipt of the associated MU-MIMO setup frame 405. Instead, the access point 105 transmits the subsequent MU-MIMO setup frame 410 regardless of whether any CTS messages are received. (In other words, the CTS messages 710-C are not used to inform the access point 105 that the destination stations 110A-C are available for reception.) However, other non-destination (e.g., third party) stations, such as the station 110H, can detect one or more of the overlapping CTS messages 710A-C (e.g., due to their timing tolerance, directional nature, etc.) and use the detected CTS message(s) 710A-C to set their respective NAVs, as described above. (Note that, in some such examples, a non-destination (e.g., third party) station may receive multiple overlapping CTS messages which, as described above, may interfere with each other and prevent the non-destination station from using the CTS messages to set its NAV.)

In a second example technical solution, CTS messages, such as the CTS messages 710A-C, are sent by destination stations, such as the destination stations 110A-C, using a new approach in which the transmitter address of a given CTS message corresponds to a same address used by the entire group of destination stations identified in the MU-MIMO setup frame 405. In some examples, the transmitter address of a given CTS message is set to group address (e.g., a group identifier) representing the group of destination stations of the MU-MIMO setup frame 405 and, thus, will be the same for all CTS messages sent by that group of destination stations. In some examples, the transmitter address of a given CTS message is set to the address of the access point 105 and, thus, will be the same for all CTS messages sent by that group of destination stations. In either case, the transmitter address included in the CTS messages for a given group of destination stations can be the same, an can be unique relative to other groups of destination stations, but can be different from an individual address uniquely associated with any one of the stations in the given group of destination stations.

For example, if the second technical solution is utilized in the example of FIG. 7, the CTS messages 710A-C transmitted by the destination stations 110A-C in the direction of the access point 105 will all be the same. As such, the overlapping CTS messages 710A-C will likely not interfere and, thus, may be decodable by the example CTS decoder 225 of the access point 105. Although the CTS decoder 225 of the access point 105 may be able to decode the overlapping CTS messages 710A-C, because the decoded transmitter address information is the same for each of the CTS messages 710A-C, the CTS decoder 225 will be unable to discriminate which one or ones of the destination stations 110A-C sent the decoded CTS message. However, the access point 105 can use the decoded CTS message to determine that at least one of the destination stations 110A-C received the MU-MIMO setup frame 405 and, thus, can proceed with transmitting the MU-MIMO frame 410 accordingly. Furthermore, other non-destination (e.g., third party) stations, such as the station 110H, can detect one or more of the overlapping CTS messages 710A-C (e.g., even if multiple CTS messages overlap) and use the detected CTS message(s) 710A-C to set their respective NAVs, as described above.

In summary, the example processing 700 of FIG. 7 includes the following operations. With reference to the preceding figures and associated descriptions, in the example of FIG. 7, the access point 105 transmits an example MU-MIMO setup frame 405 followed by an example MU-MIMO frame 410, as described above in association with FIG. 6. In the illustrated example of FIG. 7, each of the stations 110A-C receives the MU-MIMO setup frame 405 and determines, respectively, that the address information included in the MU-MIMO setup frame 405 corresponds to that station. Thus, each of the stations 110A-C prepares to receive the subsequent MU-MIMO frame 410, as described above in association with FIG. 6.

In the illustrated example of FIG. 7, the example stations 110D-F and 110H do not receive the MU-MIMO setup frame 405. For example, the stations 110D-F and 110H may not be in the directions of one or more of the stations 110A-C, and/or may not otherwise receive the MU-MIMO setup frame 405 with sufficient to successfully decode the MU-MIMO setup frame 405. As such, the stations 110D-F and 110H do not process the MU-MIMO setup frame 405 and the MU-MIMO frame 410 in the illustrated example.

In the illustrated example of FIG. 7, the example station 110G is in the direction of one or more of the stations 110A-C, and is able to successfully decode the MU-MIMO setup frame 405 transmitted by the access point 105. However, in the illustrated example, the station 110G is not in the group of destination stations for the MU-MIMO setup frame 405 and, thus, the receiver information included in the MU-MIMO setup frame 405 does not correspond to a receiver address associated with the station 110G. In the illustrated example, the station 110G instead uses the duration information specified in the duration field 510 of the MU-MIMO setup frame 405, as described above, to configure the station's NAV (e.g., which may include a timer, a counter, etc.) for the example NAV period 605 during which the station 110G is prevented from transmitting.

In the illustrated example of FIG. 7, the destination stations 110A-C respond to the MU-MIMO setup frame 405 with their respective CTS messages 710A-C within the SIFS time (e.g., and possibly within a tolerance, such as +/−10% or some other value) after the MU-MIMO setup frame 405. The stations 110A-C also configure their respective AWVs in the direction of the access point 105 in preparation for receiving the MU-MIMO frame 410. In the illustrated example, the non-destination station 110H detects the CTS message 710B transmitted by the destination station 110B, and uses the CTS message 710B, as described above, to set its NAV (e.g., which may include a timer, a counter, etc.) for the example NAV period 705 during which the station 110H is prevented from transmitting. The access point 105 then sends the MU-MIMO frame 410 directionally to the destination stations 110A-C.

The example processing 800 of FIG. 8 is similar to the example processing 700 of FIG. 7. However, the example processing 800 of FIG. 8 implements a further technical solution in which the access point 105 polls the destination stations 110A-C for the responsive CTS messages 710A-C. This technical solution can be used to avoid the technical problems associated with multiple overlapping (e.g., simultaneous) CTS messages being transmitted from different networks stations. The example processing 800 of FIG. 8 includes the following operations. With reference to the preceding figures and associated descriptions, in the example of FIG. 8, the access point 105 transmits an example MU-MIMO setup frame 405 followed by an example MU-MIMO frame 410, as described above in association with FIGS. 6-7. In the illustrated example of FIG. 8, each of the stations 110A-C receives the MU-MIMO setup frame 405 and determines, respectively, that the address information included in the MU-MIMO setup frame 405 corresponds to that station. Thus, each of the stations 110A-C prepares to receive the subsequent MU-MIMO frame 410, as described above in association with FIGS. 6-7.

In the illustrated example of FIG. 8, the example stations 110D-F and 110H do not receive the MU-MIMO setup frame 405. For example, the stations 110D-F and 110H may not be in the directions of one or more of the stations 110A-C, and/or may not otherwise receive the MU-MIMO setup frame 405 with sufficient to successfully decode the MU-MIMO setup frame 405. As such, the stations 110D-F and 110H do not process the MU-MIMO setup frame 405 and the MU-MIMO frame 410 in the illustrated example.

In the illustrated example of FIG. 8, the example station 110G is in the direction of one or more of the stations 110A-C, and is able to successfully decode the MU-MIMO setup frame 405 transmitted by the access point 105. However, in the illustrated example, the station 110G is not in the group of destination stations for the MU-MIMO setup frame 405 and, thus, the receiver information included in the MU-MIMO setup frame 405 does not correspond to a receiver address associated with the station 110G. In the illustrated example, the station 110G instead uses the duration information specified in the duration field 510 of the MU-MIMO setup frame 405, as described above, to configure the station's NAV (e.g., which may include a timer, a counter, etc.) for the example NAV period 605 during which the station 110G is prevented from transmitting.

In the illustrated example of FIG. 8, the destination stations 110A-C respond to the MU-MIMO setup frame 405 with their respective CTS messages 710A-C. However, unlike the example processing 700 of FIG. 7, in the example processing 800 of FIG. 8, example polling messages 805-810 are transmitted by the access point 105 directionally to one or more of the destination stations 110A-C to trigger the transmission of their respective CTS message(s) 710A-C. In some examples, the order in which the destination stations 110A-C are to transmit their respective CTS messages 710A-C corresponds to the order the receiver addresses for the destination stations 110A-C appear in the MU-MIMO RA container element 525 of the MU-MIMO setup frame 405. For example, in such an example, if the receiver address for the destination station 110A appeared first in the MU-MIMO RA container element 525, the destination station 110A may transmit its CTS message 710A first within the SIFS time (e.g., and further within a tolerance, such as +/−10% or some other value) after the MU-MIMO setup frame 405, and possibly without the use of a polling message, as shown in the illustrated example. If the receiver address for the destination station 110B appeared second in the MU-MIMO RA container element 525, the destination station 110B may then transmit its CTS message 710B in response to the first polling message 805 transmitted by the access point 105, as shown in the illustrated example. If the receiver address for the destination station 110C appeared third in the MU-MIMO RA container element 525, the destination station 110C may then transmit its CTS message 710B in response to the second polling message 810 transmitted by the access point 105, as shown in the illustrated example, and so on.

In some examples, the polling messages 805-810 are addressed to respective ones of the destination stations 110A-B. In some such examples, a particular one of the destination stations 110A-C transmits its respective CTS message 710A-C in response to receiving the particular polling message 805-810 addressed to it. Other polling mechanisms can additionally or alternatively be used in the example processing 800 of FIG. 8.

In the illustrated example of FIG. 8, the non-destination station 110H receives the CTS message 710B transmitted by the destination station 110B, and uses the CTS message 710B, as described above, to set its NAV (e.g., which may include a timer, a counter, etc.) for the example NAV period 705 during which the station 110H is prevented from transmitting. The access point 105 then sends the MU-MIMO frame 410 directionally to the destination stations 110A-C.

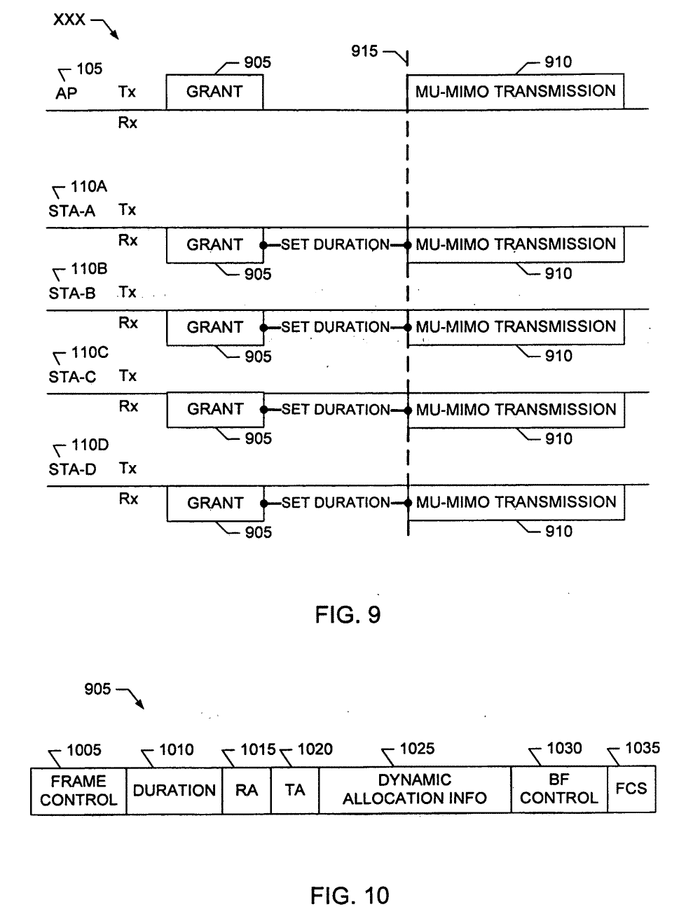

Example processing 900 capable of performed by the example access point 105 of FIGS. 1-2 and the example stations 105A-H of FIGS. 1 and 3 to initiate MU-MIMO transmissions using example grant frames is illustrated in FIG. 9. As described above, the access point 105 can use the example MU-MIMO setup frame 405 of FIGS. 4-5 to inform destination stations that they will be targeted by a subsequent downlink (DL) MU-MIMO transmission from the access point 105 in the same TxOP. In some examples, the access point 105 additionally or alternatively uses grant frames, as disclosed herein, to schedule MU-MIMO transmissions further in advance by setting rendezvous points further out in time at which the destination stations are to expect to receive the MU-MIMO transmissions.

For example, and with reference to the preceding figures and associated descriptions, in the example processing 900 of FIG. 9, the example MU-MIMO grant encoder 230 of the example access point 105 encodes and cause the access point 105 to transmit an example grant message or frame 905 multi-directionally towards a group of example destination stations 110A-D that are targeted to receive a subsequent example MU-MIMO transmission 910. The example grant message 905 sets an example rendezvous point 915 in time at which the access point 105 intends to transmit the MU-MIMO transmission 910 to the destination stations 110A-D. As illustrated in the example of FIG. 9, upon receiving and decoding the grant message 905 with their respective example MU-MIMO grant decoders 330, the destination stations 110A-D set the rendezvous point 915 for receiving the subsequent MU-MIMO transmission 910.

In some examples, at the set rendezvous point 915 in time, the destination stations 110A-D expect the access point to send the MU-MIMO transmission 910 (e.g., a physical layer convergence protocol (PLCP) data unit (PDU)) and, thus, will set their receive antennas in the direction of the access point 105. In some examples, the access point 105 performs a CCA procedure, as described above, before accessing the channel, so the start of the transmission of the MU-MIMO transmission 910 may be delayed. In some examples, if further protection of the MU-MIMO transmission 910 is desired, the access point 105 can initially transmit the example MU-MIMO setup frame 405 described above to the destination stations 110A-D at the set rendezvous point 915 in time, and possibly further request the responsive CTS messages from the destination stations 110A-D, as also described above. As described above, non-destination (e.g., third party) neighboring stations can use the MU-MIMO setup frame 405 and/or CTS messages to set their respective NAVs to prevent transmission and, thus, protect the subsequent MU-MIMO frame 410 transmitted by the access point 105. In such examples, the access point then transmits the subsequent MU-MIMO frame 410 (e.g., PDU) to the destination stations 110A-D. However, if further protection is not desired, the access point 105 may simply transmit the MU-MIMO frame 410 (e.g., PDU) to the destination stations 110A-D at the set rendezvous point 915 in time.

An example implementation of the grant message/frame 905 of FIG. 9 is illustrated in FIG. 10. The example grant message 905 may be transmitted in the directions of multiple destination stations using a multi-directional PHY channel, such as the multi-directional control PHY channel described above for sending the example MU-MIMO setup frame 405 of FIGS. 4-5. The example grant message 905 of FIG. 10 includes an example frame control field or element 1005 containing control information to identify the message as an MU-MIMO grant message. The example grant message 905 of FIG. 10 also includes an example duration field or element 1010 to specify the duration (e.g., delay) to the rendezvous point in time.

The example grant message 905 of FIG. 10 further includes an example RA field or element 1015 to specify a group receiver address (or group address or other group identifier) previously assigned to identify the group of destination stations that are to receive the subsequent MU-MIMO transmission. Additionally or alternatively, the RA element 1015 can include any appropriate information for use by, any other mechanism(s) to enable collective identification of the group of destination stations that are to receive the subsequent MU-MIMO transmission.

The example grant message 905 of FIG. 10 further includes an example TA field or element 1020 to specify a transmitter address (e.g., network address) of the transmitter of the MU-MIMO setup frame 405 (e.g., the access point 105). The example grant message 905 of FIG. 10 also includes an example dynamic allocation information (info) field or element 1025 to specify, for example, whether the destination stations addressed by the grant message 905 are to transmit a grant ACK message in response to the grant message 905. The example grant message 905 of FIG. 10 includes an example beamforming (BF) control field or element 1030 to specify whether the destination stations addressed by the grant message 905 are to perform beamforming training prior to receipt of the subsequent MU-MIMO transmission. In the illustrated example of FIG. 10, the grant message 905 further includes an example FCS field or element 1035 to provide error checking information (e.g., such as a CRC value) that can be used by receiving stations to check the integrity of the received grant message 905.

In some examples, rather than being implemented as a separate grant message 905, the example elements and functionality associated with the grant message 905 can be implemented by one or more other frames, messages, etc., transmitted by the access point 105. For example, the access point 105 could be structured to transmit a beacon frame modified to include some or all of the example elements 1005-1035 illustrated in FIG. 9.

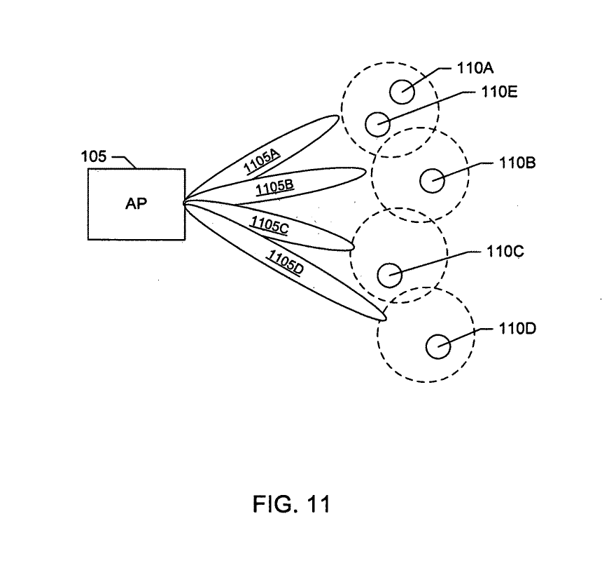

FIG. 11 illustrates example multi-directional transmission of the example grant message 905 of FIGS. 9-10 by the example access point 105 to the example destination stations 110A-D. As illustrated in the example of FIG. 11, the access point 105 uses beamforming (represented by the ellipses 1105A-D in FIG. 11) to transmit the grant message 905 simultaneously in multiple different directions towards the destination stations 110A-D. In the illustrated example of FIG. 11, the group receiver address included in the RA element 1015 identifies or otherwise is associated with the group of destination stations 110A-D. Accordingly, the destination stations 110A-D set the rendezvous point specified in the grant message 905. However, the group receiver address does not identify the network station 110E, which is located near the station 110A and is, therefore, able to receive the grant message 905. Because the group receiver address does not identify or is not otherwise associated with the network station 110E, the station 110E ignores the grant message 905 and, thus, does not set the rendezvous point specified in the grant message 905.

While example manners of implementing the example communication network 100 are illustrated in FIGS. 1-11, one or more of the elements, processes and/or devices illustrated in FIGS. 1-11 may be combined, divided, re-arranged, omitted, eliminated and/or implemented in any other way. Further, the example network access point 105, the example network stations 110A-H, the example AP transceiver 205, the example clear channel assessor 210, the example MU-MIMO setup frame encoder 215, the example MU-MIMO frame encoder 220, the example CTS message decoder 225, the example MU-MIMO grant encoder 230, the example station transceiver 305, the example MU-MIMO setup frame decoder 310, the example MU-MIMO frame decoder 315, the example NAV configurer 320, the example CTS message encoder 325, the example MU-MIMO grant decoder 330, the example MIMO digital precoder 470 and/or, more generally, the example communication network 100 of FIGS. 1-11 may be implemented by hardware, software, firmware and/or any combination of hardware, software and/or firmware. Thus, for example, any of the example network access point 105, the example network stations 110A-H, the example AP transceiver 205, the example clear channel assessor 210, the example MU-MIMO setup frame encoder 215, the example MU-MIMO frame encoder 220, the example CTS message decoder 225, the example MU-MIMO grant encoder 230, the example station transceiver 305, the example MU-MIMO setup frame decoder 310, the example MU-MIMO frame decoder 315, the example NAV configurer 320, the example CTS message encoder 325, the example MU-MIMO grant decoder 330, the example MIMO digital precoder 470 and/or, more generally, the example communication network 100 could be implemented by one or more analog or digital circuit(s), logic circuits, programmable processor(s), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example communication network 100, the example network access point 105, the example network stations 110A-H, the example AP transceiver 205, the example clear channel assessor 210, the example MU-MIMO setup frame encoder 215, the example MU-MIMO frame encoder 220, the example CTS message decoder 225, the example MU-MIMO grant encoder 230, the example station transceiver 305, the example MU-MIMO setup frame decoder 310, the example MU-MIMO frame decoder 315, the example NAV configurer 320, the example CTS message encoder 325, the example MU-MIMO grant decoder 330 and/or the example MIMO digital precoder 470 is/are hereby expressly defined to include a tangible computer readable storage device or storage disk such as a memory, a digital versatile disk (DVD), a compact disk (CD), a Blu-ray disk, etc. storing the software and/or firmware. Further still, the example communication network 100 may include one or more elements, processes and/or devices in addition to, or instead of, those illustrated in FIGS. 1-11, and/or may include more than one of any or all of the illustrated elements, processes and devices.

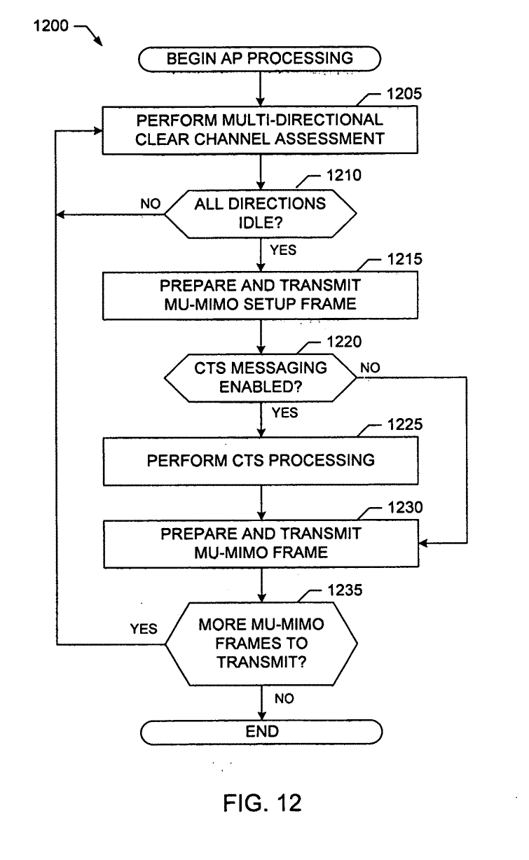

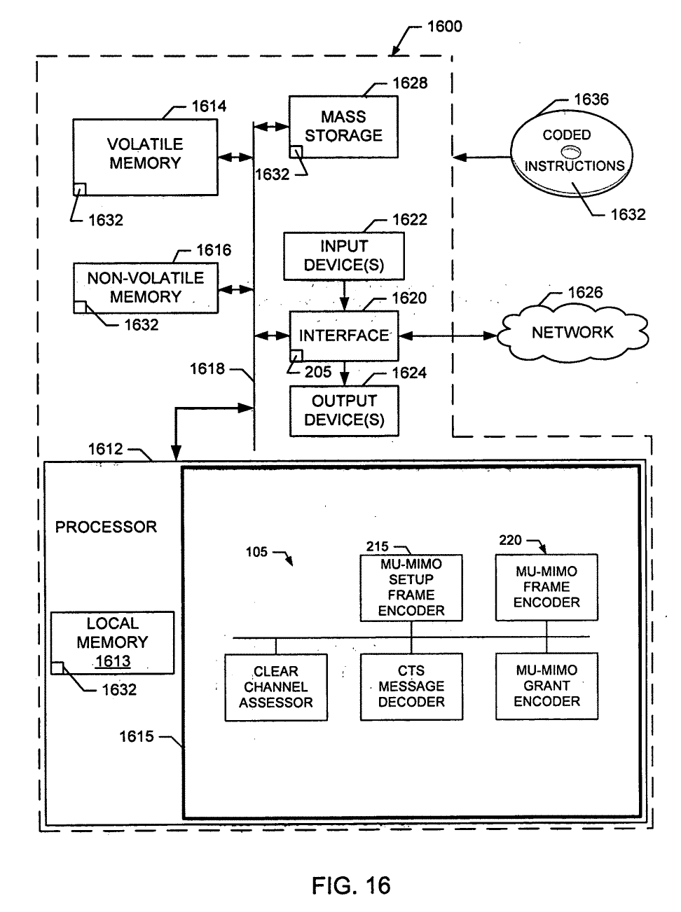

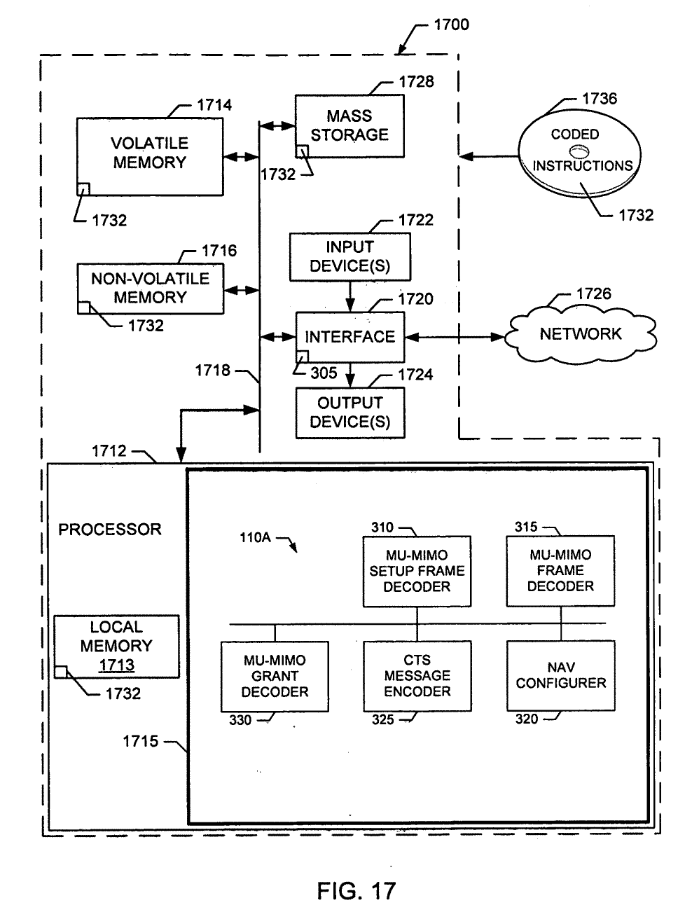

Flowcharts representative of example machine readable instructions for implementing the example communication network 100, the example network access point 105, the example network stations 110A-H, the example AP transceiver 205, the example clear channel assessor 210, the example MU-MIMO setup frame encoder 215, the example MU-MIMO frame encoder 220, the example CTS message decoder 225, the example MU-MIMO grant encoder 230, the example station transceiver 305, the example MU-MIMO setup frame decoder 310, the example MU-MIMO frame decoder 315, the example NAV configurer 320, the example CTS message encoder 325, the example MU-MIMO grant decoder 330 and/or the example MIMO digital precoder 470 are shown in FIGS. 12-15. In these examples, the machine readable instructions comprise one or more programs for execution by a processor, such as the processor 1612 and/or 1712 shown in the example processor platforms 1600 and/or 1700 discussed below in connection with FIGS. 16-17. The one or more programs, or portion(s) thereof, may be embodied in software stored on a tangible computer readable storage medium such as a CD-ROM, a floppy disk, a hard drive, a digital versatile disk (DVD), a Blu-ray Disk™, or a memory associated with the processor 1612, but the entire program or programs and/or portions thereof could alternatively be executed by a device other than the processors 1612 and/or 1712, and/or embodied in firmware or dedicated hardware (e.g., implemented by an ASIC, a PLD, an FPLD, discrete logic, etc.). Further, although the example program(s) is(are) described with reference to the flowcharts illustrated in FIGS. 12-15, many other methods of implementing the example communication network 100, the example network access point 105, the example network stations 110A-H, the example AP transceiver 205, the example clear channel assessor 210, the example MU-MIMO setup frame encoder 215, the example MU-MIMO frame encoder 220, the example CTS message decoder 225, the example MU-MIMO grant encoder 230, the example station transceiver 305, the example MU-MIMO setup frame decoder 310, the example MU-MIMO frame decoder 315, the example NAV configurer 320, the example CTS message encoder 325, the example MU-MIMO grant decoder 330 and/or the example MIMO digital precoder 470 may alternatively be used. Far example, with reference to the flowcharts illustrated in FIGS. 12-15, the order of execution of the blocks may be changed, and/or some of the blocks described may be changed, eliminated, combined and/or subdivided into multiple blocks.

As mentioned above, the example processes of FIGS. 12-15 may be implemented using coded instructions (e.g., computer and/or machine readable instructions) stored on a tangible computer readable storage medium such as a hard disk drive, a flash memory, a read-only memory (ROM), a compact disk (CD), a digital versatile disk (DVD), a cache, a random-access memory (RAM) and/or any other storage device or storage disk in which information is stored for any duration (e.g., for extended time periods, permanently, for brief instances, for temporarily buffering, and/or for caching of the information). As used herein, the term tangible computer readable storage medium is expressly defined to include any type of computer readable storage device and/or storage disk and to exclude propagating signals and to exclude transmission media. As used herein, “tangible computer readable storage medium” and “tangible machine readable storage medium” are used interchangeably. Additionally or alternatively, the example processes of FIGS. 12-15 may be implemented using coded instructions (e.g., computer and/or machine readable instructions) stored on a non-transitory computer and/or machine readable medium such as a hard disk drive, a flash memory, a ROM, a CD, a DVD, a cache, a RAM and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media. As used herein, when the phrase “at least” is used as the transition term in a preamble of a claim, it is open-ended in the same manner as the terms “comprising” and “including” are open ended. Also, as used herein, the terms “computer readable” and “machine readable” are considered equivalent unless indicated otherwise.

A first example program 1200 that may be executed to implement the example access point 105 of FIGS. 1-11 is represented by the flowchart shown in FIG. 12. With reference to the preceding figures and associated written descriptions, the example program 1200 begins execution at block 1205 at which the example clear channel assessor 210 of the access point 105 monitors a communication medium (e.g., one or more communication channels in the 60 GHz spectrum, such as one or more of the multi-directional control PHY and/or SC/OFDM channels described above) in multiple directions corresponding to a group of destination stations, such as the example stations 110A-C, to perform a clear channel assessment (CCA) of the communication medium, as described above. In response to the CCA indicating the communication medium is clear (or idle) in the multiple directions being monitored (block 1210), the clear channel assessor 210 triggers, as described above, transmitting of a MU-MIMO transmission, such as the example MU-MIMO setup frame 405, by transitioning to block 1215.

At block 1215, the example MU-MIMO setup frame encoder 215 of the access point encodes an example MU-MIMO setup frame 405 to be sent (e.g., directionally) to the group of destination stations 110A-C, as described above. The MU-MIMO setup frame 405 encoded at block 1215 specifies duration information (e.g., in the example duration element 510 described above) for a subsequent MU-MIMO frame 410 to be transmitted to the group of destination stations 110A-C. Additionally, the MU-MIMO setup frame 405 encoded at block 1215 includes information element(s) specifying receiver address information to identify the group of destination stations 110A-C. For example, the MU-MIMO setup frame 405 may include the example MU-MIMO RA elements 545-550 specifying individual receiver addresses of respective ones of the group of destination stations 110A-C that are to receive the subsequent MU-MIMO frame 410, as described above. Additionally or alternatively, the MU-MIMO setup frame 405 may include the example RA element 515 specifying a group receiver address associated with the group of destination stations 110A-C, as described above. After encoding the MU-MIMO setup frame 405, the MU-MIMO setup frame encoder 215 causes the example AP transceiver 205 to transmit the MU-MIMO setup frame 405 directionally to the group of destination stations 110A-C, as described above.

Next, if CTS messaging is enabled (block 1220), processing proceeds to block 1225 at which the example access point 105 performs CTS processing, as described above. In some examples, to enable CTS messaging, the example MU-MIMO setup frame encoder 215 may have encoded the example MU-MIMO setup frame 405 to specify, in the example CTS feedback field 540, that the group of stations 110A-C specified in the MU-MIMO setup frame 405 are to send CTS response messages in response to receiving the MU-MIMO setup frame 405. If CTS messaging is enabled (block 1220), at block 1225, the example CTS message decoder 225 of the access point 105 decodes, as described above, CTS response message(s), such as one or more of the example CTS messages 710A-C, received from the group of stations 110A-C after the MU-MIMO setup frame 405. In some such examples, the CTS message decoder 225 triggers one or more of the stations 110A-C to send their responsive CTS messages 710A-C by causing the access point 105 to transmit one or more polling message(s), such the example polling messages 805-810, to the one or more stations 110A-C, as described above.

After CTS processing at block 1225 completes, or if CTS messaging is not enabled (block 1220), processing proceeds to block 1230 at which the example MU-MIMO frame encoder 220 of the access point 105 encodes the MU-MIMO frame 410 to be sent to the group of stations 110A-C, as described above. The MU-MIMO frame encoder 220 then causes the AP transceiver 205 to transmit the MU-MIMO frame 410 directionally to the group of stations 110A-C. For example, and as described above, the MU-MIMO frame 410 may be transmitted via a channel (e.g., a multidirectional SC/OFDM PHY channel) different from a channel (e.g., a multidirectional control PHY channel) used to previously transmit the MU-MIMO setup frame 405. Additionally or alternatively, in some examples, a first portion of the MU-MIMO frame 410 (e.g., the example portion 445) is transmitted without MIMO precoding, whereas a second portion of the MU-MIMO frame 410 (e.g., the example portion 460) is transmitted with MIMO precoding, as described above.

At block 1235, the access point 105 determines whether there are more MU-MIMO frames to transmit. If there are more frames to transmit (block 1235), processing returns to block 1205 and blocks subsequent thereto to permit the access point 105 to continue transmitting MU-MIMO frames. Otherwise, execution of the example program 1200 ends.

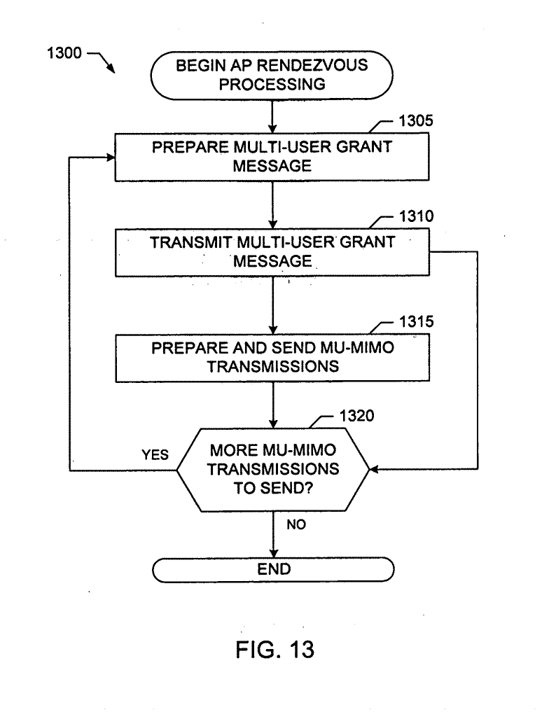

A second example program 1300 that may be executed to implement the example access point 105 of FIGS. 1-11 is represented by the flowchart shown in FIG. 13. With reference to the preceding figures and associated written descriptions, the example program 1300 begins execution at block 1305 at which the example MU-MIMO grant encoder 230 of the access point 105 encodes an example multi-user grant message 905 including time information (e.g., in the example duration element 1010) specifying a rendezvous point in time at which the access point 105 expects to send a subsequent MU-MIMO transmission (e.g., such as an example MU-MIMO setup frame 405) to a group of destination stations (e.g., such as the destination stations 110A-D), as described above. At block 1310, the MU-MIMO grant encoder 230 causes the example AP transceiver 205 of the access point 105 to transmit the encoded multi-user grant message 905 to the group of destination stations. At block 1315, the MU-MIMO grant encoder 230 triggers the access point 105 to prepare and transmit the subsequent MU-MIMO transmission (e.g., such as the example MU-MIMO setup frame 405) at the rendezvous time.

At block 1320, the access point 105 determines whether there are more MU-MIMO transmissions to send. If there are more transmissions to send (block 1320), processing returns to block 1305 and blocks subsequent thereto to permit the access point 105 to continue sending MU-MIMO transmissions. Otherwise, execution of the example program 1300 ends.

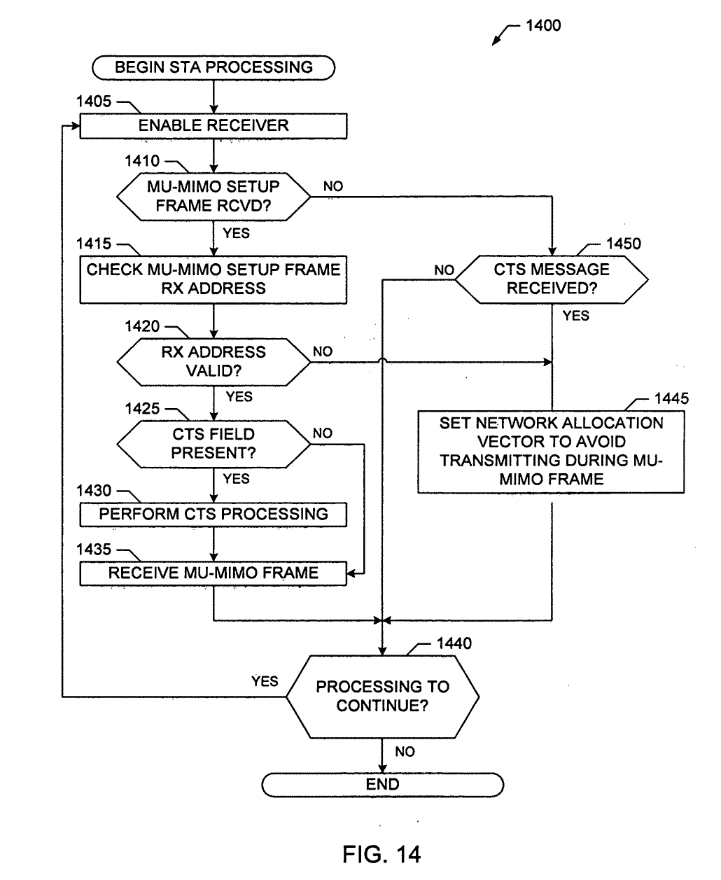

A first example program 1400 that may be executed to implement the example network station 110A of FIGS. 1-11 is represented by the flowchart shown in FIG. 14. The example program 1400 may also be executed to implement one or more of the other example stations 110B-H described above. With reference to the preceding figures and associated written descriptions, the example program 1400 begins execution at block 1405 at which the station 110A enables at least the receiver functionality of its example station transceiver 305 to receive signals from the example access point 105. At block 1410, the example MU-MIMO setup frame decoder 310 of the station 110A determines whether an example MU-MIMO setup frame 405 has been received from the access point 105. If the MU-MIMO setup frame decoder 310 receives and decodes an MU-MIMO setup frame 405 (block 1410), at block 1415, the MU-MIMO setup frame decoder 310 decodes the receiver address information included in the MU-MIMO setup frame. For example, the MU-MIMO setup frame decoder 310 may decode one or more of the individual receiver addresses specified in the example MU-MIMO RA elements 545-550 of the MU-MIMO setup frame 405 to determine whether one those addresses corresponds to a unique receiver address (e.g., AID, network address, etc.) assigned to the network station 110A, as described above. Additionally or alternatively, the MU-MIMO setup frame decoder 310 may decode a group receiver address specified in the example RA element 515 of the MU-MIMO setup frame 405 to determine whether the specified group receiver address corresponds to a group address assigned to a group of mobile stations including the network station 110A, as described above.

At block 1420, the MU-MIMO setup frame decoder 310 determines whether the receiver address information included in the decoded MU-MIMO setup frame 405 is valid or, in other words, is associated with the network station 110A. For example, the MU-MIMO setup frame decoder 310 determines that the receiver address information included in the decoded MU-MIMO setup frame 405 is valid if, for example, the information corresponds to a unique address associated with the station 110A, a group address associated with the station 110A, etc. In response to determining the receiver address information included in the decoded MU-MIMO setup frame 405 is valid (block 1420), processing proceeds to block 1425 and blocks subsequent thereto. At block 1425, the MU-MIMO setup frame decoder 310 determines whether the example CTS feedback field 540 is present in the decoded MU-MIMO setup frame 405. If the CTS feedback field 540 is present (block 1425), at block 1430, the station 110A performs CTS processing, as described above.

For example, at block 1430, the example CTS message encoder 325 of the station 110A encodes an example CTS response message 710A to send to the access point 105 in response to the CTS feedback field 540 indicating that CTS feedback is to be transmitted by a receiving station, as described above. In some examples, at block 1430, the CTS message encoder 325 triggers the station transceiver 305 to transmit the CTS response message 710A in response to receipt of a polling message from the access point 105, such as one of the example polling messages 805-810, as described above.

After CTS processing completes at block 1430, or if the CTS feedback field 540 is not present in the received MU-MIMO setup frame 405 (block 1425), at block 1435 the example MU-MIMO frame decoder 315 of the station 110A configures reception of a subsequently MU-MIMO frame 410 based on the duration information specified in the decoded MU-MIMO setup frame 405 (e.g., included in the example duration element 510). In some examples, at block 1435, MU-MIMO frame decoder 315 configures the station 110A to receive the subsequent MU-MIMO frame 410 via a channel (e.g., a multidirectional SC/OFDM PHY channel) different from a channel (e.g., a multidirectional control PHY channel) via which the MU-MIMO setup frame 405 was previously received. Additionally or alternatively, in some examples, the MU-MIMO frame decoder 315 configures the station 110A to receive a first portion of the MU-MIMO frame 410 (e.g., the example portion 445) without MIMO precoding, and to receive a second portion of the MU-MIMO frame 410 (e.g., the example portion 460) with MIMO precoding, as described above. Then, at the appropriate time, the MU-MIMO frame decoder 315 receives and decodes the MU-MIMO frame 410 transmitted by the access point 105. Processing then proceeds to block 1440.

Returning to block 1420, in response to determining the receiver address information included in the decoded MU-MIMO setup frame 405 is not valid (e.g., is not an individual address or a group address associated with the station 110A), processing proceeds to block 1445. At block 1445, the example NAV configurer 320 of the station 110A configures the station's NAV based on the duration information specified in the decoded MU-MIMO setup frame 405 (e.g., included in the example duration element 510), as described above, to prevent the station 110A from transmitting on the communication medium during the TxOP in which the subsequent MU-MIMO frame 410 associated with the MU-MIMO setup frame 405 is to be transmitted by the access point 105. Processing then proceeds to block 1440.

Returning to block 1410, if an MU-MIMO setup frame 405 has not been received, processing proceeds to block 1450 at which the example NAV configurer 320 of the station 110A determines whether a CTS response message has been detected from another network station, such as one of the stations 110B-H. In response to receipt of a CTS response message from another network station (block 1450), processing proceeds to block 1445 at which the example NAV configurer 320 of the station 110A configures the station's NAV, as described above, to prevent the station 110A from transmitting on the communication medium during a period of time beginning after receipt of the CTS message and covering the TxOP in which a subsequent MU-MIMO frame 410 is expected to be transmitted by the access point 105. After the NAV is configured at block 1445, or if a CTS response message has not been received (block 1450), processing proceeds to block 1440.

At block 1440, the station 110A determines whether processing is to continue. If processing is to continue (block 1440), processing returns to block 1405 and blocks subsequent thereto. Otherwise, execution of the example program 1400 ends.

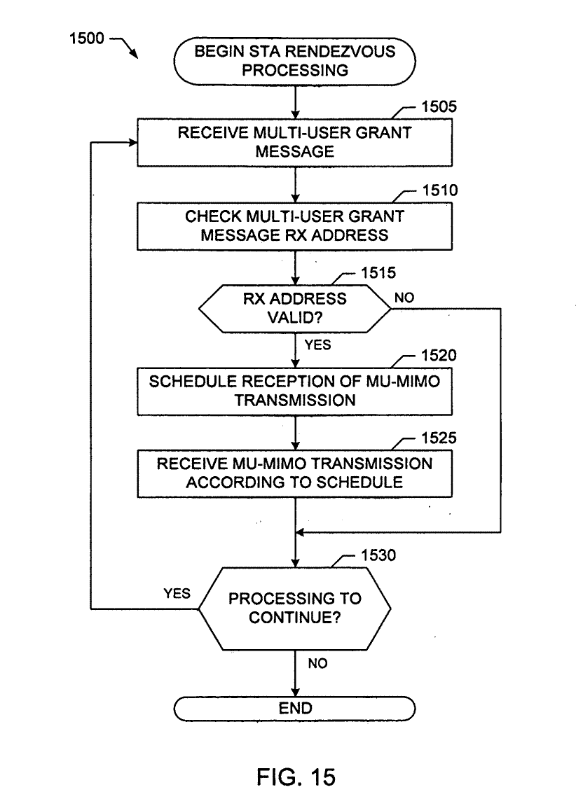

A second example program 1500 that may be executed to implement the example network station 110A of FIGS. 1-11 is represented by the flowchart shown in FIG. 15. The example program 1500 may also be executed to implement one or more of the other example stations 110B-H described above. With reference to the preceding figures and associated written descriptions, the example program 1500 begins execution at block 1505 at which the example MU-MIMO grant decoder 330 of the station 110A receives an example multi-user grant message 905 from the example access point 105. At block 1510, in response to receipt of the multi-user grant message 905, the MU-MIMO grant decoder 330 determines whether group address information specified in the grant message 905 (e.g., included in the RA element 1015) is valid or, in other words, corresponds to a group address associated with a group of stations including the station 110A, as described above. In response to determining the group address information specified in the grant message 905 is valid (block 1515), at block 1520, the MU-MIMO grant decoder 330 uses duration information specified in the grant message 905 (e.g., included in the example duration element 1010), as described above, to configure the station 110A to receive a subsequent MU-MIMO transmission from the access point at a subsequent rendezvous point in time. For example, the MU-MIMO grant decoder 330 may cause the example MU-MIMO setup frame decoder 310 of the station 110A to configure reception of the example MU-MIMO setup frame 405 to occur, based on the specified duration information, at the subsequent rendezvous time. At block 1525, the station 110A receives the subsequent MU-MIMO transmission at the schedule rendezvous time, as described above.

At block 1530, the station 110A determines whether processing is to continue. If processing is to continue (block 1530), processing returns to block 1505 and blocks subsequent thereto. Otherwise, execution of the example program 1500 ends.

FIG. 16 is a block diagram of an example processor platform 1600 structured to execute the instructions of FIGS. 12 and/or 13 to implement the example network access point 105 of FIGS. 1-11. The processor platform 1600 can be, for example, a server or any other type of computing device.

The processor platform 1600 of the illustrated example includes a processor 1612. The processor 1612 of the illustrated example is hardware. For example, the processor 1612 can be implemented by one or more integrated circuits, logic circuits, microprocessors or controllers from any desired family or manufacturer. In the illustrated example of FIG. 16, the processor 1612 includes one or more example processing cores 1615 configured via example instructions 1632, which include the example instructions of FIGS. 12 and/or 13, to implement the example clear channel assessor 210, the example MU-MIMO setup frame encoder 215, the example MU-MIMO frame encoder 220, the example CTS message decoder 225, the example MU-MIMO grant encoder 230 and/or the example MIMO digital precoder 470 of FIGS. 2 and 4.

The processor 1612 of the illustrated example includes a local memory 1613 (e.g., a cache). The processor 1612 of the illustrated example is in communication with a main memory including a volatile memory 1614 and a non-volatile memory 1616 via a link 1618. The link 1618 may be implemented by a bus, one or more point-to-point connections, etc., or a combination thereof. The volatile memory 1614 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 1616 may be implemented by flash memory and/or any other desired type of memory device. Access to the main memory 1614, 1616 is controlled by a memory controller.

The processor platform 1600 of the illustrated example also includes an interface circuit 1620. The interface circuit 1620 may be implemented by any type of interface standard, such as an Ethernet interface, a universal serial bus (USB), and/or a PCI express interface.

In the illustrated example, one or more input devices 1622 are connected to the interface circuit 1620. The input device(s) 1622 permit(s) a user to enter data and commands into the processor 1612. The input device(s) can be implemented by, for example, an audio sensor, a microphone, a camera (still or video), a keyboard, a button, a mouse, a touchscreen, a track-pad, a trackball, a trackbar (such as an isopoint), a voice recognition system and/or any other human-machine interface. Also, many systems, such as the processor platform 1600, can allow the user to control the computer system and provide data to the computer using physical gestures, such as, but not limited to, hand or body movements, facial expressions, and face recognition.

One or more output devices 1624 are also connected to the interface circuit 1620 of the illustrated example. The output devices 1624 can be implemented, for example, by display devices (e.g., a light emitting diode (LED), an organic light emitting diode (OLED), a liquid crystal display, a cathode ray tube display (CRT), a touchscreen, a tactile output device, a printer and/or speakers). The interface circuit 1620 of the illustrated example, thus, typically includes a graphics driver card, a graphics driver chip or a graphics driver processor.

The interface circuit 1620 of the illustrated example also includes a communication device such as a transmitter, a receiver, a transceiver, a modem and/or network interface card to facilitate exchange of data with external machines (e.g., computing devices of any kind) via a network 1626 (e.g., an Ethernet connection, a digital subscriber line (DSL), a telephone line, coaxial cable, a cellular telephone system, etc.). In the illustrated example of FIG. 16, the interface circuit 1620 also implements the example AP transceiver 205.

The processor platform 1600 of the illustrated example also includes one or more mass storage devices 1628 for storing software and/or data. Examples of such mass storage devices 1628 include floppy disk drives, hard drive disks, compact disk drives, Blu-ray disk drives, RAID (redundant array of independent disks) systems, and digital versatile disk (DVD) drives.

Coded instructions 1632 corresponding to the instructions of FIGS. 12 and/or 13 may be stored in the mass storage device 1628, in the volatile memory 1614, in the non-volatile memory 1616, in the local memory 1613 and/or on a removable tangible computer readable storage medium, such as a CD or DVD 1636.

FIG. 17 is a block diagram of an example processor platform 1700 structured to execute the instructions of FIGS. 14 and/or 15 to implement the example network station 110A of FIGS. 1-11. The processor platform 1700 can be, for example, a server, a personal computer, a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box a digital camera, or any other type of computing device.

The processor platform 1700 of the illustrated example includes a processor 1712. The processor 1712 of the illustrated example is hardware. For example, the processor 1712 can be implemented by one or more integrated circuits, logic circuits, microprocessors or controllers from any desired family or manufacturer. In the illustrated example of FIG. 17, the processor 1712 includes one or more example processing cores 1715 configured via example instructions 1732, which include the example instructions of FIGS. 14 and/or 15, to implement the example MU-MIMO setup frame decoder 310, the example MU-MIMO frame decoder 315, the example NAV configurer 320, the example CTS message encoder 325 and/or the example MU-MIMO grant decoder 330 of FIG. 3.

The processor 1712 of the illustrated example includes a local memory 1713 (e.g., a cache). The processor 1712 of the illustrated example is in communication with a main memory including a volatile memory 1714 and a non-volatile memory 1716 via a link 1718. The link 1718 may be implemented by a bus, one or more point-to-point connections, etc., or a combination thereof. The volatile memory 1714 may be implemented by SDRAM, DRAM, RDRAM and/or any other type of random access memory device. The non-volatile memory 1716 may be implemented by flash memory and/or any other desired type of memory device. Access to the main memory 1714, 1716 is controlled by a memory controller.

The processor platform 1700 of the illustrated example also includes an interface circuit 1720. The interface circuit 1720 may be implemented by any type of interface standard, such as an Ethernet interface, a USB interface, and/or a PCI express interface.

In the illustrated example, one or more input devices 1722 are connected to the interface circuit 1720. The input device(s) 1722 permit(s) a user to enter data and commands into the processor 1712. The input device(s) can be implemented by, for example, an audio sensor, a microphone, a camera (still or video), a keyboard, a button, a mouse, a touchscreen, a track-pad, a trackball, a trackbar (such as an isopoint), a voice recognition system and/or any other human-machine interface. Also, many systems, such as the processor platform 1700, can allow the user to control the computer system and provide data to the computer using physical gestures, such as, but not limited to, hand or body movements, facial expressions, and face recognition.

One or more output devices 1724 are also connected to the interface circuit 1720 of the illustrated example. The output devices 1724 can be implemented, for example, by display devices (e.g., an LED, an OLED, a liquid crystal display, a CRT, a touchscreen, a tactile output device, a printer and/or speakers). The interface circuit 1720 of the illustrated example, thus, typically includes a graphics driver card, a graphics driver chip or a graphics driver processor.

The interface circuit 1720 of the illustrated example also includes a communication device such as a transmitter, a receiver, a transceiver, a modem and/or network interface card to facilitate exchange of data with external machines (e.g., computing devices of any kind) via a network 1726 (e.g., an Ethernet connection, a DSL, a telephone line, coaxial cable, a cellular telephone system, etc.). In the illustrated example of FIG. 17, the interface circuit 1720 also implements the example station transceiver 305.

The processor platform 1700 of the illustrated example also includes one or more mass storage devices 1728 for storing software and/or data. Examples of such mass storage devices 1728 include floppy disk drives, hard drive disks, compact disk drives, Blu-ray disk drives, RAID systems, and DVD drives.

Coded instructions 1732 corresponding to the instructions of FIGS. 14 and/or 15 may be stored in the mass storage device 1728, in the volatile memory 1714, in the non-volatile memory 1716, in the local memory 1713 and/or on a removable tangible computer readable storage medium, such as a CD or DVD 1736.

The following further examples, which include subject matter such as a method for MU-MIMO communication, means for performing MU-MIMO communication, at least one computer-readable medium including instructions that, when executed by a processor, cause the processor to perform MU-MIMO communication, and an apparatus and/or a system for MU-MIMO communication are disclosed herein.

Example 1 is a multi-user multiple input multiple output (MU-MIMO) communication method, which includes preparing, with a processor, an MU-MIMO setup frame specifying duration information for a subsequent MU-MIMO frame to be transmitted and a group of stations to receive the subsequent MU-MIMO frame. The method of example 1 also includes transmitting the MU-MIMO setup frame, and after the transmitting of the MU-MIMO setup frame, transmitting the MU-MIMO frame.

Example 2 includes the subject matter of example 1, wherein the MU-MIMO setup frame is implemented by a CTS-to-self frame including elements to specify the duration information for the subsequent MU-MIMO frame and the group of stations to receive the subsequent MU-MIMO frame.

Example 3 includes the subject matter of examples 1 or 2, wherein the MU-MIMO setup frame includes an information element specifying respective receiver addresses corresponding to respective ones of the stations that are to receive the subsequent MU-MIMO frame.

Example 4 includes the subject matter of examples 1 or 2, wherein the MU-MIMO setup frame includes a group receiver address associated with the group of stations.

Example 5 includes the subject matter of any one of examples 1 to 4, wherein the transmitting of the MU-MIMO setup frame includes transmitting the MU-MIMO setup frame in multiple directions using a first multidirectional physical layer channel different from a second multidirectional physical layer channel used to transmit the MU-MIMO frame.

Example 6 includes the subject matter of example 5, wherein the transmitting of the MU-MIMO frame includes transmitting a first portion of the MU-MIMO frame in the multiple directions using the second multidirectional physical layer channel without MIMO precoding, and transmitting a second portion of the MU-MIMO frame in the multiple directions using the second multidirectional physical layer channel with MIMO precoding.

Example 7 includes the subject matter of any one of examples 1 to 6, wherein the MU-MIMO setup frame includes clear-to-send (CTS) feedback element specifying whether a CTS response is to be transmitted by the group of stations specified in the MU-MIMO setup frame.

Example 8 includes the subject matter of example 7, and further includes receiving a first CTS response from a first one of the group of stations after the transmitting of the MU-MIMO setup frame.

Example 9 includes the subject matter of example 8, and further includes transmitting a polling message to the first one of the group of stations prior to the receiving of the first CTS response.

Example 10 includes the subject matter of any one of examples 1 to 9, and further includes, prior to the transmitting of the MU-MIMO setup frame, monitoring a communication medium in multiple directions corresponding to the group of stations to perform a clear channel assessment, and triggering the transmitting of the MU-MIMO setup frame to occur in response to the clear channel assessment indicating the communication medium is clear in the multiple directions.

Example 11 includes the subject matter of any one of examples 1 to 10, and further includes preparing a grant message including time information specifying a rendezvous time at which the MU-MIMO setup frame is to be transmitted, transmitting the grant message, and triggering the transmitting of the MU-MIMO setup frame to occur based on the rendezvous time.

Example 12 is a tangible computer readable storage medium including computer readable instructions which, when executed, cause a network access point to at least prepare a multi-user multiple input multiple output (MU-MIMO) setup frame specifying duration information for a subsequent MU-MIMO frame to be transmitted and a group of stations to receive the subsequent MU-MIMO frame, transmit the MU-MIMO setup frame, and after the MU-MIMO setup frame is transmitted, transmit the MU-MIMO frame.

Example 13 includes the subject matter of example 12, wherein the MU-MIMO setup frame is implemented by a CTS-to-self frame including elements to specify the duration information for the subsequent MU-MIMO frame and the group of stations to receive the subsequent MU-MIMO frame.

Example 14 includes the subject matter of examples 12 or 13, wherein the MU-MIMO setup frame includes an information element specifying respective receiver addresses corresponding to respective ones of the stations that are to receive the subsequent MU-MIMO frame.

Example 15 includes the subject matter of examples 12 or 13, wherein the MU-MIMO setup frame includes a group receiver address associated with the group of stations.

Example 16 includes the subject matter of any one of examples 12 to 15, wherein the computer readable instructions, when executed, further cause the network access point to transmit the MU-MIMO setup frame by transmitting the MU-MIMO setup frame in multiple directions using a first multidirectional physical layer channel different from a second multidirectional physical layer channel used to transmit the MU-MIMO frame.

Example 17 includes the subject matter of example 16, wherein the computer readable instructions, when executed, further cause the network access point to transmit the MU-MIMO frame by transmitting a first portion of the MU-MIMO frame in the multiple directions using the second multidirectional physical layer channel without MIMO precoding, and transmitting a second portion of the MU-MIMO frame in the multiple directions using the second multidirectional physical layer channel with MIMO precoding.

Example 18 includes the subject matter of any one of examples 12 to 17, wherein the MU-MIMO setup frame includes a clear-to-send (CTS) feedback element specifying whether a CTS response is to be transmitted by the group of stations specified in the MU-MIMO setup frame.

Example 19 includes the subject matter of example 18, wherein the computer readable instructions, when executed, further cause the network access point to receive a first CTS response from a first one of the group of stations after the MU-MIMO setup frame is transmitted.

Example 20 includes the subject matter of example 19, wherein the computer readable instructions, when executed, further cause the network access point to transmit a polling message to the first one of the group of stations prior the first CTS response being received.

Example 21 includes the subject matter of any one of examples 12 to 20, wherein the computer readable instructions, when executed, further cause the network access point to, prior to the MU-MIMO setup frame being transmitted, monitor a communication medium in multiple directions corresponding to the group of stations to perform a clear channel assessment, and trigger the transmitting of the MU-MIMO setup frame to occur in response to the clear channel assessment indicating the communication medium is clear in the multiple directions.

Example 22 includes the subject matter of any one of examples 12 to 21, wherein the computer readable instructions, when executed, further cause the network access point to prepare a grant message including time information specifying a rendezvous time at which the MU-MIMO setup frame is to be transmitted, transmit the grant message, and trigger the transmitting of the MU-MIMO setup frame to occur based on the rendezvous time.

Example 23 is tangible computer readable storage medium including computer readable instructions which, when executed, cause a processor to perform the method defined in any one of examples 1 to 11.

Example 24 is a network access point including a multi-user multiple input multiple output (MU-MIMO) setup frame encoder to prepare an MU-MIMO setup frame specifying duration information for a subsequent MU-MIMO frame to be transmitted and a group of stations to receive the subsequent MU-MIMO frame. The network access point of example 24 also includes a transceiver to transmit the MU-MIMO setup frame, and after the MU-MIMO setup frame is transmitted, transmit the MU-MIMO frame.

Example 25 includes the subject matter of example 24, wherein the MU-MIMO setup frame is implemented by a CTS-to-self frame including elements to specify the duration information for the subsequent MU-MIMO frame and the group of stations to receive the subsequent MU-MIMO frame.

Example 26 includes the subject matter of examples 24 or 25, wherein the MU-MIMO setup frame includes an information element specifying respective receiver addresses corresponding to respective ones of the stations that are to receive the subsequent MU-MIMO frame.

Example 27 includes the subject matter of examples 24 or 25, wherein the MU-MIMO setup frame includes a group receiver address associated with the group of stations.

Example 28 includes the subject matter of any one of examples 24 to 27, wherein the transceiver is further to transmit the MU-MIMO setup frame in multiple directions using a first multidirectional physical layer channel different from a second multidirectional physical layer channel used to transmit the MU-MIMO frame.

Example 29 includes the subject matter of example 28, wherein the transceiver is further to transmit a first portion of the MU-MIMO frame in the multiple directions using the second multidirectional physical layer channel without MIMO precoding, and transmit a second portion of the MU-MIMO frame in the multiple directions using the second multidirectional physical layer channel with MIMO precoding.

Example 30 includes the subject matter of any one of examples 24 to 29, wherein the MU-MIMO setup frame includes a clear-to-send (CTS) feedback element specifying whether a CTS response is to be transmitted by the group of stations specified in the MU-MIMO setup frame.

Example 31 includes the subject matter of example 30, and further includes a CTS message decoder to decode a first CTS response from a first one of the group of stations after the MU-MIMO setup frame is transmitted.

Example 32 includes the subject matter of example 31, wherein the transceiver is further to transmit a polling message to the first one of the group of stations prior to receipt of the first CTS response.

Example 33 includes the subject matter of any one of examples 24 to 32, and further includes a clear channel assessor to, prior to the MU-MIMO setup frame being transmitted, monitor a communication medium in multiple directions corresponding to the group of stations to perform a clear channel assessment, and trigger the transmitting of the MU-MIMO setup frame to occur in response to the clear channel assessment indicating the communication medium is clear in the multiple directions.

Example 34 includes the subject matter of any one of examples 24 to 33, and further includes an MU-MIMO grant encoder to prepare a grant message including time information specifying a rendezvous time at which the MU-MIMO setup frame is to be transmitted, and trigger the transmitting of the MU-MIMO setup frame to occur based on the rendezvous time.

Example 35 is an apparatus including a processor configured to perform the method defined in any one of examples 1 to 11.

Example 36 is an apparatus including means for preparing a multi-user multiple input multiple output (MU-MIMO) setup frame specifying duration information for a subsequent MU-MIMO frame to be transmitted and a group of stations to receive the subsequent MU-MIMO frame. The apparatus of example 36 also includes means for transmitting the MU-MIMO setup frame, and means for transmitting the MU-MIMO frame after the transmitting of the MU-MIMO setup frame.

Example 37 includes the subject matter of example 36, wherein the MU-MIMO setup frame is implemented by a CTS-to-self frame including elements to specify the duration information for the subsequent MU-MIMO frame and the group of stations to receive the subsequent MU-MIMO frame.

Example 38 includes the subject matter of examples 36 or 37, wherein the MU-MIMO setup frame includes an information element specifying respective receiver addresses corresponding to respective ones of the stations that are to receive the subsequent MU-MIMO frame.

Example 39 includes the subject matter of examples 36 or 37, wherein the MU-MIMO setup frame includes a group receiver address associated with the group of stations.

Example 40 includes the subject matter of any one of examples 36 to 39, wherein the means for transmitting the MU-MIMO setup frame includes means for transmitting the MU-MIMO setup frame in multiple directions using a first multidirectional physical layer channel different from a second multidirectional physical layer channel used to transmit the MU-MIMO frame.

Example 41 includes the subject matter of example 40, wherein the means for transmitting the MU-MIMO frame includes means for transmitting a first portion of the MU-MIMO frame in the multiple directions using the second multidirectional physical layer channel without MIMO precoding, and transmitting a second portion of the MU-MIMO frame in the multiple directions using the second multidirectional physical layer channel with MIMO precoding.

Example 42 includes the subject matter of any one of examples 36 to 41, wherein the MU-MIMO setup frame includes a clear-to-send (CTS) feedback element specifying whether a CTS response is to be transmitted by the group of stations specified in the MU-MIMO setup frame.

Example 43 includes the subject matter of example 42, and further includes means for receiving a first CTS response from a first one of the group of stations after the transmitting of the MU-MIMO setup frame.

Example 44 includes the subject matter of example 43, and further includes means for transmitting a polling message to the first one of the group of stations prior to the receiving of the first CTS response.

Example 45 includes the subject matter of any one of examples 36 to 44, and further includes means for monitoring, prior to the transmitting of the MU-MIMO setup frame, a communication medium in multiple directions corresponding to the group of stations to perform a clear channel assessment, and means for triggering the transmitting of the MU-MIMO setup frame to occur in response to the clear channel assessment indicating the communication medium is clear in the multiple directions.

Example 46 includes the subject matter of any one of examples 36 to 45, and further includes means for preparing a grant message including time information specifying a rendezvous time at which the MU-MIMO setup frame is to be transmitted, means for transmitting the grant message, and means for triggering the transmitting of the MU-MIMO setup frame to occur based on the rendezvous time.

Example 47 is a multi-user multiple input multiple output (MU-MIMO) communication method including, in response to receiving a MU-MIMO setup frame, determining, with a processor, whether receiver address information included in the MU-MIMO setup frame corresponds to a first receiver address associated with a network station. The method of example 47 also includes, in response to the receiver address information corresponding to the first receiver address, configuring, with the processor, receiving of a subsequent MU-MIMO frame at the network station based on duration information specified in the MU-MIMO setup frame. The method of example 47 further includes, in response to the receiver address information not corresponding to the first receiver address, configuring, with the processor, a network allocation vector based on the duration information specified in the MU-MIMO setup frame to prevent the network station from transmitting on a communication medium while the subsequent MU-MIMO frame is being transmitted on the communication medium.

Example 48 includes the subject matter of example 47, wherein the MU-MIMO setup frame is implemented by a CTS-to-self frame including elements to specify the duration information for the subsequent MU-MIMO frame and the group of stations to receive the subsequent MU-MIMO frame.

Example 49 includes the subject matter of examples 47 or 48, wherein the receiver address information is an individual receiver address included in an information element of the MU-MIMO setup frame, and the first receiver address is a unique receiver address assigned to the network station.

Example 50 includes the subject matter of examples 47 or 48, wherein the receiver address information corresponds to a group address included in a receiver address element of the MU-MIMO setup frame, and the first receiver address is a first group address assigned to a first group of stations including the network station.

Example 51 includes the subject matter of any one of example 47 to 50, wherein the configuring of the receiving of the subsequent MU-MIMO frame at the network station includes configuring the network station to receive the MU-MIMO frame using a second multidirectional physical layer channel different from a first multidirectional physical layer channel via which the MU-MIMO setup frame was received.

Example 52 includes the subject matter of example 51, wherein the configuring of the receiving of the subsequent MU-MIMO frame at the network station further includes configuring the network station to receive a first portion of the MU-MIMO frame without MIMO precoding, and configuring the network station to receive a second portion of the MU-MIMO frame with MIMO precoding.

Example 53 includes the subject matter of any one of example 47 to 52, and further includes, in response to the receiver address information corresponding to the first receiver address, determining whether the MU-MIMO setup frame further includes a clear-to-send (CTS) feedback element, and in response to the CTS feedback element indicating CTS feedback is to be transmitted, transmitting a CTS message responsive to the MU-MIMO setup frame.

Example 54 includes the subject matter of example 53, and further includes triggering the transmitting of the CTS message to occur in response to receiving a polling message.

Example 55 includes the subject matter of any one of example 47 to 54, and further includes, in response to receiving a CTS message, configuring the network allocation vector to prevent the network station from transmitting on the communication medium for a first duration beginning after receipt of the CTS message.

Example 56 includes the subject matter of any one of example 47 to 55, and further includes, in response to receiving a grant message, determining whether group address information included in the grant message corresponds to a first group address associated with a first group of stations including the network station, and in response to the group address information corresponding to the first group address, configuring the receiving of the MU-MIMO setup frame based on duration information specified in the grant message.

Example 57 is a tangible computer readable storage medium including computer readable instructions which, when executed, cause a network station in a communication network to at least, in response to receipt of a multi-user multiple input multiple output (MU-MIMO) setup frame, determine whether receiver address information included in the MU-MIMO setup frame corresponds to a first receiver address associated with the network station; in response to the receiver address information corresponding to the first receiver address, configure reception of a subsequent MU-MIMO frame at the network station based on duration information specified in the MU-MIMO setup frame; and in response to the receiver address information not corresponding to the first receiver address, configure a network allocation vector based on the duration information specified in the MU-MIMO setup frame to prevent the network station from transmitting on a communication medium while the subsequent MU-MIMO frame is being transmitted on the communication medium.

Example 58 includes the subject matter of example 57, wherein the MU-MIMO setup frame is implemented by a CTS-to-self frame including elements to specify the duration information for the subsequent MU-MIMO frame and the group of stations to receive the subsequent MU-MIMO frame.

Example 59 includes the subject matter of examples 57 or 58, wherein the receiver address information is an individual receiver address included in an information element of the MU-MIMO setup frame, and the first receiver address is a unique receiver address assigned to the network station.

Example 60 includes the subject matter of examples 57 or 58, wherein the receiver address information corresponds to a group address included in a receiver address element of the MU-MIMO setup frame, and the first receiver address is a first group address assigned to a first group of stations including the network station.

Example 61 includes the subject matter of any one of example 47 to 60, wherein the instructions, when executed, cause the network station to configure reception of the subsequent MU-MIMO frame by configuring the network station to receive the MU-MIMO frame using a second multidirectional physical layer channel different from a first multidirectional physical layer channel via which the MU-MIMO setup frame was received.

Example 62 includes the subject matter of example 61, wherein the instructions, when executed, further cause the network station to configure reception of a subsequent MU-MIMO by configuring the network station to receive a first portion of the MU-MIMO frame without MIMO precoding, and configuring the network station to receive a second portion of the MU-MIMO frame with MIMO precoding.

Example 63 includes the subject matter of any one of example 47 to 62, wherein the instructions, when executed, further cause the network station to, in response to the receiver address information corresponding to the first receiver address, determine whether the MU-MIMO setup frame further includes a clear-to-send (CTS) feedback element, and in response to the CTS feedback element indicating CTS feedback is to be transmitted, transmit a CTS message responsive to the MU-MIMO setup frame.

Example 64 includes the subject matter of example 63, wherein the instructions, when executed, further cause the network station to trigger the transmission of the CTS message to occur in response to receipt of a polling message.

Example 65 includes the subject matter of any one of example 47 to 64, wherein the instructions, when executed, further cause the network station to, in response to receipt of a CTS message, configure the network allocation vector to prevent the network station from transmitting on the communication medium for a first duration beginning after receipt of the CTS message.

Example 66 includes the subject matter of any one of example 47 to 65, wherein the instructions, when executed, further cause the network station to, in response to receipt of a grant message, determine whether group address information included in the grant message corresponds to a first group address associated with a first group of stations including the network station, and in response to the group address information corresponding to the first group address, configure the reception of the MU-MIMO setup frame based on duration information specified in the grant message.

Example 67 is tangible computer readable storage medium including computer readable instructions which, when executed, cause a processor to perform the method defined in any one of examples 47 to 56.

Example 68 is a network station including a multi-user multiple input multiple output (MU-MIMO) setup frame decoder to, in response to receipt of an MU-MIMO setup frame, determine whether receiver address information included in the MU-MIMO setup frame corresponds to a first receiver address associated with the network station. The network station of example 68 also includes an MU-MIMO frame decoder to, in response to the receiver address information corresponding to the first receiver address, configure reception of a subsequent MU-MIMO frame at the network station based on duration information specified in the MU-MIMO setup frame. The network station of example 68 further includes a network allocation vector (NAV) configurer to, in response to the receiver address information not corresponding to the first receiver address, configure a network allocation vector based on the duration information specified in the MU-MIMO setup frame to prevent the network station from transmitting on a communication medium while the subsequent MU-MIMO frame is being transmitted on the communication medium.

Example 69 includes the subject matter of example 68, wherein the MU-MIMO setup frame is implemented by a CTS-to-self frame including elements to specify the duration information for the subsequent MU-MIMO frame and the group of stations to receive the subsequent MU-MIMO frame.

Example 70 includes the subject matter of examples 68 or 69, wherein the receiver address information is an individual receiver address included in an information element of the MU-MIMO setup frame, and the first receiver address is a unique receiver address assigned to the network station.

Example 71 includes the subject matter of examples 68 or 69, wherein the receiver address information corresponds to a group address included in a receiver address element of the MU-MIMO setup frame, and the first receiver address is a first group address assigned to a first group of stations including the network station.

Example 72 includes the subject matter of any one of examples 68 to 71, wherein the MU-MIMO frame decoder is to configure reception of the subsequent MU-MIMO frame by configuring the network station to receive the MU-MIMO frame using a second multidirectional physical layer channel different from a first multidirectional physical layer channel via which the MU-MIMO setup frame was received.

Example 73 includes the subject matter of example 72, wherein the MU-MIMO frame decoder is further to configure reception of the subsequent MU-MIMO frame by configuring the network station to receive a first portion of the MU-MIMO frame without MIMO precoding, and configuring the network station to receive a second portion of the MU-MIMO frame with MIMO precoding.

Example 74 includes the subject matter of any one of examples 68 to 73, wherein the MU-MIMO setup frame decoder is further to determine whether the MU-MIMO setup frame further includes a clear-to-end (CTS) feedback element in response to the receiver address information corresponding to the first receiver address; and further including a CTS message encoder to encode a CTS message responsive to the MU-MIMO setup frame in response to the CTS feedback element indicating CTS feedback is to be transmitted.

Example 75 includes the subject matter of example 74, wherein the CTS message encoder is further to trigger the transmission of the CTS message to occur in response to receipt of a polling message.

Example 76 includes the subject matter of any one of examples 68 to 75, wherein the NAV configurer is further to, in response to receipt of a CTS message, configure the network allocation vector to prevent the network station from transmitting on the communication medium for a first duration beginning after receipt of the CTS message.

Example 77 includes the subject matter of any one of examples 68 to 76, and further includes an MU-MIMO grant decoder to, in response to receipt of a grant message, determine whether group address information included in the grant message corresponds to a first group address associated with a first group of stations including the network station, wherein the MU-MIMO setup frame decoder is further to configure the reception of the MU-MIMO setup frame based on duration information specified in the grant message in response to the group address information corresponding to the first group address.

Example 78 is an apparatus including a processor configured to perform the method defined in any one of examples 47 to 56.

Example 79 is an apparatus including means for determining whether receiver address information included in a multi-user multiple input multiple output (MU-MIMO) setup frame corresponds to a first receiver address associated with a network station in response to receiving the MU-MIMO setup frame. The apparatus of example 79 also includes, means for configuring receiving of a subsequent MU-MIMO frame at the network station based on duration information specified in the MU-MIMO setup frame in response to the receiver address information corresponding to the first receiver address. The method of example 47 further includes means for configuring a network allocation vector based on the duration information specified in the MU-MIMO setup frame to prevent the network station from transmitting on a communication medium while the subsequent MU-MIMO frame is being transmitted on the communication medium in response to the receiver address information not corresponding to the first receiver address.

Example 80 includes the subject matter of example 79, wherein the MU-MIMO setup frame is implemented by a CTS-to-self frame including elements to specify the duration information for the subsequent MU-MIMO frame and the group of stations to receive the subsequent MU-MIMO frame.

Example 81 includes the subject matter of examples 79 or 80, wherein the receiver address information is an individual receiver address included in an information element of the MU-MIMO setup frame, and the first receiver address is a unique receiver address assigned to the network station.

Example 82 includes the subject matter of examples 79 or 80, wherein the receiver address information corresponds to a group address included in a receiver address element of the MU-MIMO setup frame, and the first receiver address is a first group address assigned to a first group of stations including the network station.

Example 83 includes the subject matter of any one of example 79 to 82, wherein the means for configuring of the receiving of the subsequent MU-MIMO frame at the network station includes means for configuring the network station to receive the MU-MIMO frame using a second multidirectional physical layer channel different from a first multidirectional physical layer channel via which the MU-MIMO setup frame was received.

Example 84 includes the subject matter of example 83, wherein the means for configuring of the receiving of the subsequent MU-MIMO frame at the network station further includes means for configuring the network station to receive a first portion of the MU-MIMO frame without MIMO precoding, and configuring the network station to receive a second portion of the MU-MIMO frame with MIMO precoding.

Example 85 includes the subject matter of any one of example 79 to 84, and further includes means for determining whether the MU-MIMO setup frame further includes a clear-to-send (CTS) feedback element in response to the receiver address information corresponding to the first receiver address, and means for transmitting a CTS message responsive to the MU-MIMO setup frame in response to the CTS feedback element indicating CTS feedback is to be transmitted.

Example 86 includes the subject matter of example 85, and further includes means for triggering the transmitting of the CTS message to occur in response to receiving a polling message.

Example 87 includes the subject matter of any one of example 79 to 86, and further includes means for configuring the network allocation vector to prevent the network station from transmitting on the communication medium for a first duration beginning after receipt of the CTS message in response to receiving a CTS message.

Example 88 includes the subject matter of any one of example 79 to 87, and further includes means for determining whether group address information included in the grant message corresponds to a first group address associated with a first group of stations including the network station in response to receiving a grant message, and means for configuring the receiving of the MU-MIMO setup frame based on duration information specified in the grant message in response to the group address information corresponding to the first group address.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

1. A multi-user multiple input multiple output (MU-MIMO) communication method comprising:
preparing, by executing an instruction with a processor, an MU-MIMO setup frame specifying duration information for a subsequent MU-MIMO frame to be transmitted and a group of stations to receive the subsequent MU-MIMO frame;
directionally transmitting the MU-MIMO setup frame directed in a plurality of different directions, directional transmitting of the MU-MIMO setup frame in a first one of the directions being delayed relative to directional transmitting of the MU-MIMO setup frame in a second one of the directions, the second direction is different from the first direction; and
after the transmitting of the MU-MIMO setup frame, transmitting the MU-MIMO frame.

2. The method as defined in claim 1, wherein the MU-MIMO setup frame is implemented by a CTS-to-self frame including elements to specify the duration information for the subsequent MU-MIMO frame and the group of stations to receive the subsequent MU-MIMO frame.

3. The method as defined in claim 1, wherein the MU-MIMO setup frame includes an information element specifying respective receiver addresses corresponding to respective ones of the stations that are to receive the subsequent MU-MIMO frame.

4. The method as defined in claim 1, wherein the MU-MIMO setup frame includes a group receiver address associated with the group of stations.

5. The method as defined in claim 1, wherein directionally transmitting the MU-MIMO setup frame includes transmitting the MU-MIMO setup frame in multiple directions using a first multidirectional physical layer channel different from a second multidirectional physical layer channel used to transmit the MU-MIMO frame.

6. The method as defined in claim 5, wherein the transmitting of the MU-MIMO frame includes:
transmitting a first portion of the MU-MIMO frame in the multiple directions using the second multidirectional physical layer channel without MIMO precoding; and
transmitting a second portion of the MU-MIMO frame in the multiple directions using the second multidirectional physical layer channel with MIMO precoding.

7. The method as defined in claim 1, wherein the MU-MIMO setup frame includes a clear-to-send (CTS) feedback element specifying whether a CTS response is to be transmitted by the group of stations specified in the MU-MIMO setup frame.

8. The method as defined in claim 7, further including receiving a first CTS response from a first one of the group of stations after the transmitting of the MU-MIMO setup frame.

9. The method as defined in claim 8, further including transmitting a polling message to the first one of the group of stations prior to the receiving of the first CTS response.

10. The method as defined in claim 1, further including:
prior to the transmitting of the MU-MIMO setup frame, monitoring a communication medium in multiple directions corresponding to the group of stations to perform a clear channel assessment; and
triggering the transmitting of the MU-MIMO setup frame to occur in response to the clear channel assessment indicating the communication medium is clear in the multiple directions.

11. The method as defined in claim 1, further including:
preparing a grant message including time information specifying a rendezvous time at which the MU-MIMO setup frame is to be transmitted;
transmitting the grant message; and
triggering the transmitting of the MU-MIMO setup frame to occur based on the rendezvous time.

12. A tangible computer readable storage medium comprising computer readable instructions which, when executed, cause a network access point to at least:
prepare a multi-user multiple input multiple output (MU-MIMO) setup frame specifying duration information for a subsequent MU-MIMO frame to be transmitted and a group of stations to receive the subsequent MU-MIMO frame;
directionally transmit the MU-MIMO setup frame directed in a plurality of different directions, directional transmission of the MU-MIMO setup frame in a first one of the directions being delayed relative to directional transmission of the MU-MIMO setup frame in a second one of the directions, the second direction is different from the first direction; and
after the MU-MIMO setup frame is transmitted, transmit the MU-MIMO frame.

13. The tangible computer readable storage medium as defined in claim 12, wherein the MU-MIMO setup frame is implemented by a CTS-to-self frame including elements to specify the duration information for the subsequent MU-MIMO frame and the group of stations to receive the subsequent MU-MIMO frame.

14. The tangible computer readable storage medium as defined in claim 12, wherein the MU-MIMO setup frame includes an information element specifying respective receiver addresses corresponding to respective ones of the stations that are to receive the subsequent MU-MIMO frame.

15. The tangible computer readable storage medium as defined in claim 12, wherein the MU-MIMO setup frame includes a group receiver address associated with the group of stations.

16. The tangible computer readable storage medium as defined in claim 12, wherein the MU-MIMO setup frame includes a clear-to-send (CTS) feedback element specifying whether a CTS response is to be transmitted by the group of stations specified in the MU-MIMO setup frame.

17. The tangible computer readable storage medium as defined in claim 12, wherein the computer readable instructions, when executed, further cause the network access point to:
prior to the MU-MIMO setup frame being transmitted, monitor a communication medium in multiple directions corresponding to the group of stations to perform a clear channel assessment; and
trigger the transmitting of the MU-MIMO setup frame to occur in response to the clear channel assessment indicating the communication medium is clear in the multiple directions.

18. The tangible computer readable storage medium as defined in claim 12, wherein the computer readable instructions, when executed, further cause the network access point to:
prepare a grant message including time information specifying a rendezvous time at which the MU-MIMO setup frame is to be transmitted;
transmit the grant message; and
trigger the transmitting of the MU-MIMO setup frame to occur based on the rendezvous time.

19. A network access point comprising:
a multi-user multiple input multiple output (MU-MIMO) setup frame encoder to prepare an MU-MIMO setup frame specifying duration information for a subsequent MU-MIMO frame to be transmitted and a group of stations to receive the subsequent MU-MIMO frame; and
a transceiver to:
directionally transmit the MU-MIMO setup frame directed in a plurality of different directions, directional transmission of the MU-MIMO setup frame in a first one of the directions being delayed relative to directional transmission of the MU-MIMO setup frame in a second one of the directions, the second direction is different from the first direction; and
after the MU-MIMO setup frame is transmitted, transmit the MU-MIMO frame.

20. The network access point as defined in claim 19, wherein the MU-MIMO setup frame is implemented by a CTS-to-self frame including elements to specify the duration information for the subsequent MU-MIMO frame and the group of stations to receive the subsequent MU-MIMO frame.

21. The network access point as defined in claim 19, wherein the MU-MIMO setup frame includes an information element specifying respective receiver addresses corresponding to respective ones of the stations that are to receive the subsequent MU-MIMO frame.

22. The network access point as defined in claim 19, wherein the MU-MIMO setup frame includes a group receiver address associated with the group of stations.

23. The network access point as defined in claim 19, wherein the MU-MIMO setup frame includes a clear-to-send (CTS) feedback element specifying whether a CTS response is to be transmitted by the group of stations specified in the MU-MIMO setup frame.

24. The network access point as defined in claim 19, further including a clear channel assessor to:
prior to the MU-MIMO setup frame being transmitted, monitor a communication medium in multiple directions corresponding to the group of stations to perform a clear channel assessment; and
trigger the transmitting of the MU-MIMO setup frame to occur in response to the clear channel assessment indicating the communication medium is clear in the multiple directions.

25. The network access point as defined in claim 19, further including an MU-MIMO grant encoder to:
prepare a grant message including time information specifying a rendezvous time at which the MU-MIMO setup frame is to be transmitted; and
trigger the transmitting of the MU-MIMO setup frame to occur based on the rendezvous time.
